(19) United States
(12) Patent Application Publication
(10) Pub. No.: US 2026/0100547 A1
(43) Pub. Date: Apr. 9, 2026

(54) PLUG CONNECTOR HAVING END NODE TERMINATION MODULE

(71) Applicant: TE Connectivity Solutions GmbH, Schaffhausen (CH)

(72) Inventors: Aaron PAYNE, Middletown, PA (US); Jakob C. COALMER, Middletown, PA (US)

(21) Appl. No.: 19/213,182

(22) Filed: Aug. 1, 2025

Related U.S. Application Data
(60) Provisional application No. 63/704,605, filed on Oct. 8, 2024.
(60) Provisional application No. 63/704,608, filed on Oct. 8, 2024.
(60) Provisional application No. 63/704,623, filed on Oct. 8, 2024.
(60) Provisional application No. 63/704,641, filed on Oct. 8, 2024.
(60) Provisional application No. 63/704,634, filed on Oct. 8, 2024.
(60) Provisional application No. 63/704,646, filed on Oct. 8, 2024.
(60) Provisional application No. 63/706,100, filed on Oct. 17, 2024.

(51) Int. Cl. H01R 13/66; H01R 12/70; H01R 12/72; H01R 12/75

(52) U.S. Cl. CPC H01R 13/6658; H01R 12/7088; H01R 12/724; H01R 12/727; H01R 12/75; H01R 2201/26

(57) ABSTRACT

A plug connector includes a plug housing having a power contact channel and module channels between a mating end and a cable end. The plug connector includes a power contact in the power contact channel, a data module received in the first module channel, and an end node termination module received in the second module channel. The data module includes a data module housing holding signal contacts terminated to ends of signal wires of a data cable. The end node termination module includes a termination module housing with a pocket holding an end node PCB with a control circuit having an end node control component. Jumper contacts are held by the plug housing including a signal contact mating interface electrically connected to the corresponding signal contact and an end node mating interface electrically connected to the end node termination module to electrically connect the signal contacts to the end node control circuit within the plug connector.

### CROSS REFERENCE TO RELATED APPLICATIONS

This application claims benefit to U.S. Application No. 63/704,605, filed 08-Oct.-2024; U.S. Application No. 63/704,608, filed 08-Oct.-2024; U.S. Application No. 63/704,623, filed 08-Oct.-2024; U.S. Application No. 63/704,641, filed 08-Oct.-2024; U.S. Application No. 63/704,634, filed 08-Oct.-2024; U.S. Application No. 63/704,646, filed 08-Oct.-2024; and U.S. Application No. 63/706,100, filed on 17-Oct.-2024 the subject matter of which are herein incorporated by reference in their entirety.

### BACKGROUND OF THE INVENTION

The subject matter herein relates generally to electrical connector systems.

Modern vehicles are increasingly reliant on sophisticated electronic control systems to manage various engine functions, including fuel injection, ignition timing, emissions control, and turbocharging. At the heart of these systems is the Engine Control Unit (ECU), a microcontroller-based device that interfaces with numerous sensors and actuators throughout the vehicle. Communication between the ECU and these peripheral components is typically facilitated via serial communication buses, such as Controller Area Network (CAN), Local Interconnect Network (LIN), or similar proprietary or standardized networks.

In such systems, proper signal integrity and network performance are essential for the accurate and timely exchange of data. To achieve this, termination networks are often employed at the ends of communication buses to match impedance, reduce reflections, and ensure reliable data transmission. These termination networks often include resistive and/or capacitive components configured on the printed circuit board (PCB) of the ECU.

However, the implementation of termination and signal conditioning circuitry directly on the ECU's PCB poses several challenges. First, the ECU is a highly space-constrained environment where real estate on the PCB is at a premium. The addition of termination networks and associated signal processing components consumes valuable board area that could otherwise be allocated to essential processing, memory, or power management components. Second, the design and integration of these components add to the overall complexity of the ECU, increasing design time, cost, and potential failure points in the system.

### BRIEF DESCRIPTION OF THE INVENTION

In an embodiment, a plug connector is provided and includes a plug housing having a mating end and a cable end. The mating end is configured to be mated with a header connector. The plug housing includes a power contact channel between the mating end and the cable end. The plug housing includes first and second module channels between the mating end and the cable end. The plug connector includes a power contact received in the power contact channel. The power contact is terminated to a power cable. The power contact includes a mating end configured to be mated to the header connector. The plug connector includes a data module received in the first module channel. The data module includes a data module housing holding signal contacts terminated to ends of signal wires of a data cable. Each signal contact includes a mating end configured to be mated to the header connector. The plug connector includes a common mode end node termination module received in the second module channel. The common mode end node termination module includes a termination module housing with a pocket. The common mode end node termination module includes a common mode signal processing assembly received in the pocket. The common mode signal processing assembly includes an end node printed circuit board (PCB) with a common mode control circuit. The common mode signal processing assembly includes a common mode signal processing component mounted to the end node PCB for processing signals on the common mode control circuit. The plug connector includes jumper contacts held by the plug housing. Each jumper contact includes a signal contact mating interface electrically connected to the corresponding signal contact and an end node mating interface electrically connected to the common mode end node termination module to electrically connect the signal contacts to the common mode control circuit within the plug connector. The plug connector includes a ground jumper contact coupled to an electrically grounded component of the plug connector. The ground jumper contact includes a ground contact mating interface electrically connected to the common mode end node termination module to electrically ground the common mode end node termination module.

In another embodiment, a common mode end node termination module for a plug connector is provided and includes a termination module housing includes a main body having a pocket. The main body includes access windows open to the pocket. The common mode end node termination module includes a common mode signal processing assembly received in the pocket. The common mode signal processing assembly includes an end node printed circuit board (PCB) with a common mode control circuit. The common mode signal processing assembly includes a common mode signal processing component mounted to the end node PCB for processing signals on the common mode control circuit. The end node PCB includes a perimeter edge between opposite first and second surfaces of the end node PCB. The common mode signal processing component mounted to the first surface. The end node PCB includes a signal edge pad along the perimeter edge. The end node PCB includes a ground edge pad along the perimeter edge. The signal edge pad and the ground edge pad coupled to the common mode control circuit. The end node PCB is configured to be electrically connected to a signal contact of the plug connector by a jumper contact of the plug connector through the corresponding access window and the end node PCB is configured to be electrically connected to an electrically grounded component of the plug connector by a ground jumper contact of the plug connector through the corresponding access window.

In a further embodiment, an electrical connector system is provided and includes a header connector that includes a header housing holding header contacts. The header housing includes a receptacle. The header contacts include mating ends in the receptacle. The electrical connector system includes a plug connector received in the receptacle and mated to the header contacts. The plug connector includes a plug housing having a mating end and a cable end. The mating end is configured to be mated with a header connector. The plug housing includes a power contact channel between the mating end and the cable end. The plug housing includes first and second module channels between the mating end and the cable end. The plug connector includes a power contact received in the power contact channel. The power contact is terminated to a power cable. The power contact includes a mating end configured to be mated to the header connector. The plug connector includes a data module received in the first module channel. The data module includes a data module housing holding signal contacts terminated to ends of signal wires of a data cable. Each signal contact includes a mating end configured to be mated to the header connector. The plug connector includes a common mode end node termination module received in the second module channel. The common mode end node termination module includes a termination module housing with a pocket. The common mode end node termination module includes a common mode signal processing assembly received in the pocket. The common mode signal processing assembly includes an end node printed circuit board (PCB) with a common mode control circuit. The common mode signal processing assembly includes a common mode signal processing component mounted to the end node PCB for processing signals on the common mode control circuit. The plug connector includes jumper contacts held by the plug housing. Each jumper contact includes a signal contact mating interface electrically connected to the corresponding signal contact and an end node mating interface electrically connected to the common mode end node termination module to electrically connect the signal contacts to the common mode control circuit within the plug connector. The plug connector includes a ground jumper contact coupled to an electrically grounded component of the plug connector. The ground jumper contact includes a ground contact mating interface electrically connected to the common mode end node termination module to electrically ground the common mode end node termination module.

### BRIEF DESCRIPTION OF THE DRAWINGS

FIG. 1 is a perspective view of an electrical connector system in accordance with an exemplary embodiment.

FIG. 2 is a side view of the electrical connector system in accordance with an exemplary embodiment.

FIG. 3 is a cross-sectional view of the electrical connector system in accordance with an exemplary embodiment.

FIG. 4 is a bottom perspective view of the header connector in accordance with an exemplary embodiment.

FIG. 5 is a rear view of the header connector in accordance with an exemplary embodiment.

FIG. 6 is a front view of the header connector in accordance with an exemplary embodiment.

FIG. 7 is a perspective view of a portion of the plug connector showing a pair of the power contacts in accordance with an exemplary embodiment.

FIG. 8 is a front perspective view of the plug connector in accordance with an exemplary embodiment.

FIG. 9 is a top view of the plug connector in accordance with an exemplary embodiment.

FIG. 10 is a front view of the plug connector in accordance with an exemplary embodiment.

FIG. 11 is a front view of the plug connector in accordance with an exemplary embodiment.

FIG. 12 is a front view of the plug connector in accordance with an exemplary embodiment.

FIG. 13 is a front view of the plug connector in accordance with an exemplary embodiment.

FIG. 14 is a front view of the plug connector in accordance with an exemplary embodiment.

FIG. 15 is an exploded view of the data module in accordance with an exemplary embodiment.

FIG. 16 is a partially assembled view of the data module in accordance with an exemplary embodiment.

FIG. 17 is an assembled view of the data module in accordance with an exemplary embodiment.

FIG. 18 is a side view of the data module in accordance with an exemplary embodiment.

FIG. 19 is an exploded view of the data module in accordance with an exemplary embodiment.

FIG. 20 is an assembled view of the data module in accordance with an exemplary embodiment.

FIG. 21 is an exploded view of the end node termination module in accordance with an exemplary embodiment.

FIG. 22 is a top view of the termination module housing in accordance with an exemplary embodiment.

FIG. 23 illustrates the signal processing assembly in accordance with an exemplary embodiment.

FIG. 24 illustrates the signal processing assembly in accordance with an exemplary embodiment.

FIG. 25 illustrates a plurality of the end node PCBs during manufacture in accordance with an exemplary embodiment.

FIG. 26 is a perspective view of the signal processing assembly in accordance with an exemplary embodiment showing the jumper contacts and the ground jumper contact coupled to the signal processing assembly.

FIG. 27 is a side view of the end node termination module in accordance with an exemplary embodiment.

FIG. 28 is a cross-sectional view of the end node termination module in accordance with an exemplary embodiment.

FIG. 29 is an exploded view of a portion of the plug connector in accordance with an exemplary embodiment.

FIG. 30 is a top view of the position assurance device in accordance with an exemplary embodiment.

FIG. 31 is an end view of the position assurance device in accordance with an exemplary embodiment.

FIG. 32 is a cross-sectional view of the plug connector in accordance with an exemplary embodiment.

FIG. 33 is a perspective view of a portion of the plug connector in accordance with an exemplary embodiment showing the internal components of the plug connector.

FIG. 34 is a top view of a portion of the plug connector in accordance with an exemplary embodiment showing the internal components of the plug connector.

FIG. 35 is a front view of a portion of the plug connector in accordance with an exemplary embodiment showing the internal components of the plug connector.

FIG. 36 is a perspective view of a portion of the plug connector in accordance with an exemplary embodiment showing the internal components of the plug connector.

FIG. 37 is a top view of a portion of the plug connector in accordance with an exemplary embodiment showing the internal components of the plug connector.

FIG. 38 is a front view of a portion of the plug connector in accordance with an exemplary embodiment showing the internal components of the plug connector.

### DETAILED DESCRIPTION OF THE INVENTION

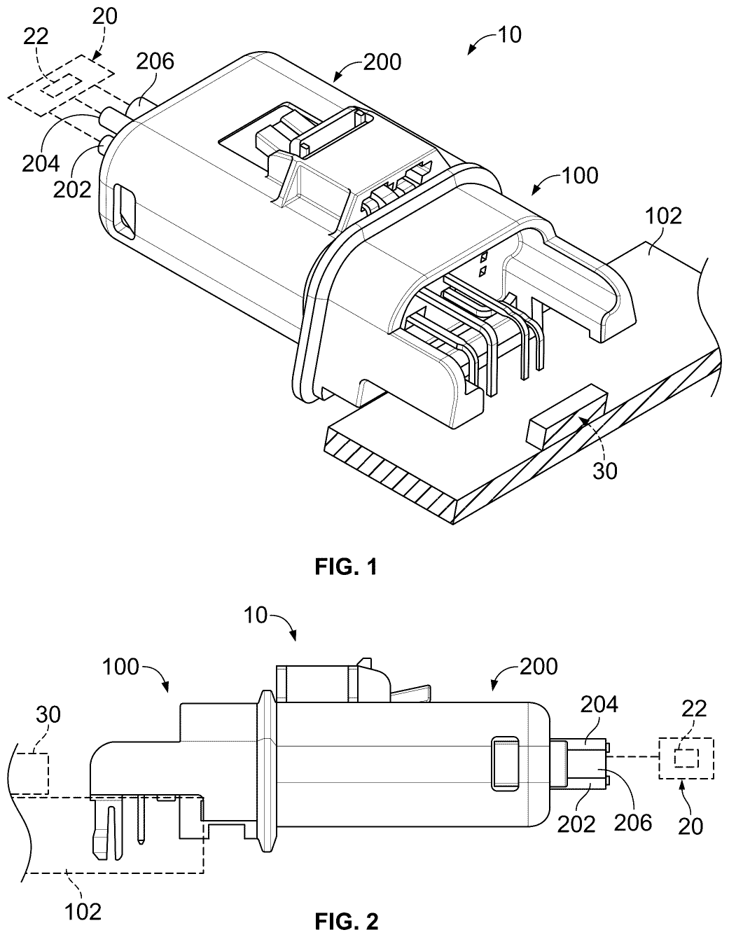

FIG. 1 is a perspective view of an electrical connector system 10 in accordance with an exemplary embodiment. FIG. 2 is a side view of the electrical connector system 10 in accordance with an exemplary embodiment. The electrical connector system 10 includes a header connector 100 and a plug connector 200 coupled to the header connector 100. The header connector 100 is coupled to a first electrical component 20 of the electrical connector system 10. The plug connector 200 is coupled to a second electrical component 30 of the electrical connector system 10. The header connector 100 and the plug connector 200 electrically connects the first and second electrical components 20, 30.

In various embodiments, the electrical connector system 10 may be used in an automotive application. For example, the electrical connector system 10 may be used in a vehicle, such as an electric vehicle. The electrical connector system may form part of a battery system, an engine control unit (ECU), an engine management system, a vehicle infotainment system, a vehicle lighting system, a vehicle heating and cooling system, or other system within a vehicle. The electrical connector system 10 may be used in other applications other than automotive applications, such as aeronautical applications, marine applications, military applications, industrial applications, robotic applications, data communication systems, network systems, server systems, building wiring systems, and the like. In an exemplary embodiment, the electrical connector system 10 is used for data and/or power transmission between the electrical components 20, 30. The electrical connector system 10 may be used for low speed data transmission and/or high speed data transmission. In various embodiments, the connectors 100, 200 may form a common mode end termination for the electrical connector system 10. In other various embodiments, the connectors 100, 200 may form a differential mode end termination for the electrical connector system 10.

In an exemplary embodiment, the plug connector 200 is a cable connector provided at ends of cables 202 extending from the plug connector 200 to the second electrical component 30. In an exemplary embodiment, the cables 202 include one or more power cables 204 and one or more data cables 206. In the illustrated embodiment, the plug connector 200 includes a pair of the power cables 204 representing a positive supply power cable and a negative return power cable. In an exemplary embodiment, the negative power cable may be referenced to ground to supply a ground reference for the plug connector 200. In alternative embodiments, the power cables 204 may include three power cables representing a positive, negative, and ground power cable. In other various embodiments, greater or fewer power cables 204 may be provided in the plug connector 200. In an exemplary embodiment, the data cables 206 may be twisted-pair cables having a pair of signal wires therein that are twisted along the length of the data cables 206. In an exemplary embodiment, the data cables 206 may be unshielded twisted-pair cables having a pair of unshielded signal wires. Other types of data cables may be used in alternative embodiments, such as coaxial cables, twinaxial cables, single wire cables, multi wire cables, and the like.

In an exemplary embodiment, the header connector 100 is mounted to a circuit board 102. The circuit board 102 may be part of the electrical component 20. The electrical component 20 may include one or more electronic devices 22 mounted to the circuit board 102. For example, the electronic devices 22 may be an integrated circuit, a chip, a processor, a memory module, a computing device, a network device, a switch device, a data communication device, or other type of electronic device. In various embodiments, multiple header connectors 100 may be mounted to the circuit board 102 and electrically connected to the electronic device(s) 22. The header connector 100 may be mounted to another component, such as a fixture, a panel, a wall, a chassis, or other component of the electrical component 20. In alternative embodiments, the header connector 100 may be a cable connector rather than a board connector wherein the header connector 100 is terminated to ends of cables.

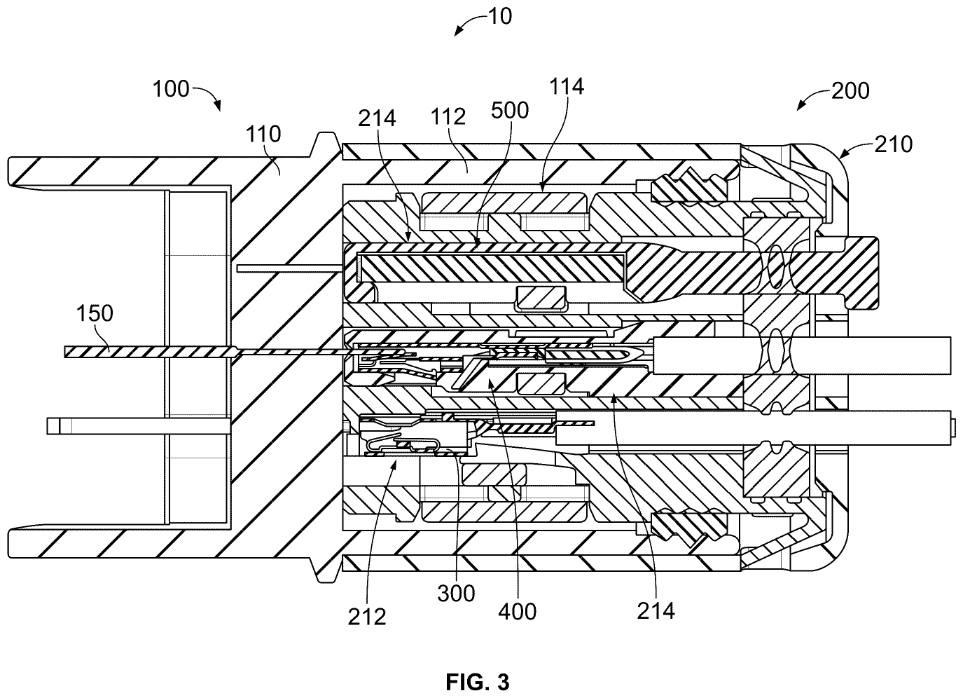

FIG. 3 is a cross-sectional view of the electrical connector system 10 in accordance with an exemplary embodiment. FIG. 3 shows the plug connector 200 mated with the header connector 100. For example, a portion of the plug connector 200 is plugged into the header connector 100. In an exemplary embodiment, the electrical connector system 10 includes a sealed mating interface between the header connector 100 and the plug connector 200.

In an exemplary embodiment, the header connector 100 includes a header housing 110 holding a plurality of header contacts 150. The header housing 110 includes walls 112 forming a receptacle 114. The header contacts 150 extend into the receptacle 114. The receptacle 114 receives the plug connector 200. The plug connector 200 is mated to the header contacts 150 in the receptacle 114.

In an exemplary embodiment, the plug connector 200 includes a plug housing 210. In various embodiments, the plug connector 200 includes one or more power contacts 300 held by the plug housing 210, such as in power contact channels 212 of the plug housing 210. In various embodiments, the plug connector 200 includes one or more data modules 400 held by the plug housing 210, such as in module channels 214 of the plug housing 210. In various embodiments, the plug connector 200 includes an end node termination module 500 held by the plug housing 210, such as in the module channels 214 of the plug housing 210. In an exemplary embodiment, the plug connector 200 is modular allowing configuration of the plug connector 200 by interchangeably receiving various data modules 400 and/or end node termination modules 500. For example, the module channels 214 may be configured to receive different types of data modules 400 and/or different types of end node termination modules 500 therein to change the configuration of the plug connector 200.

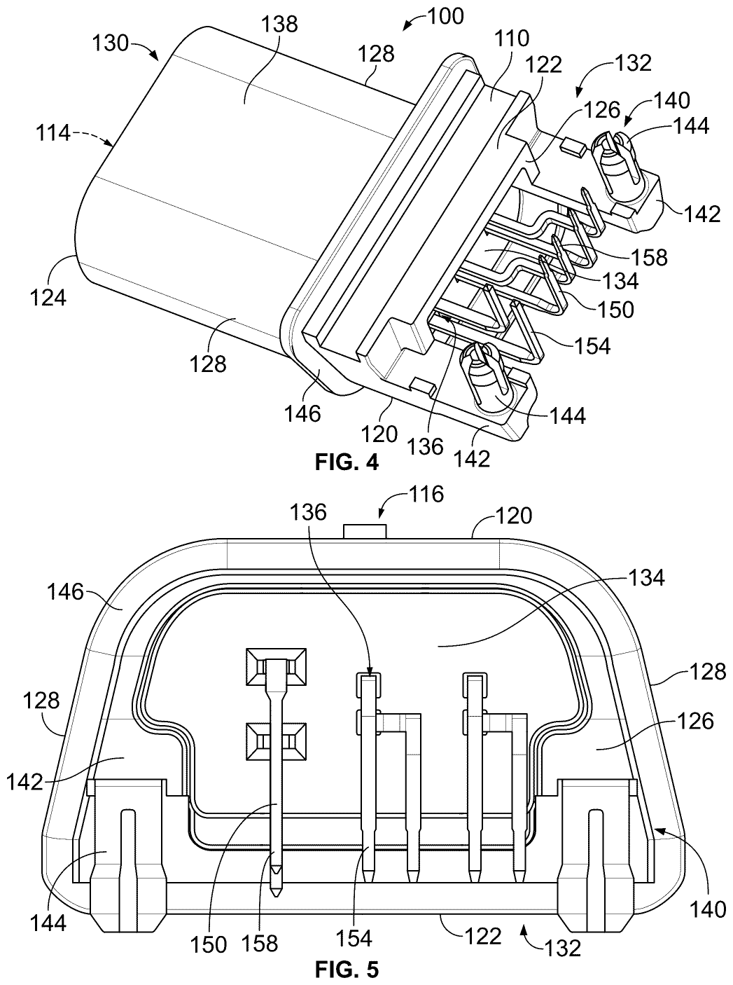

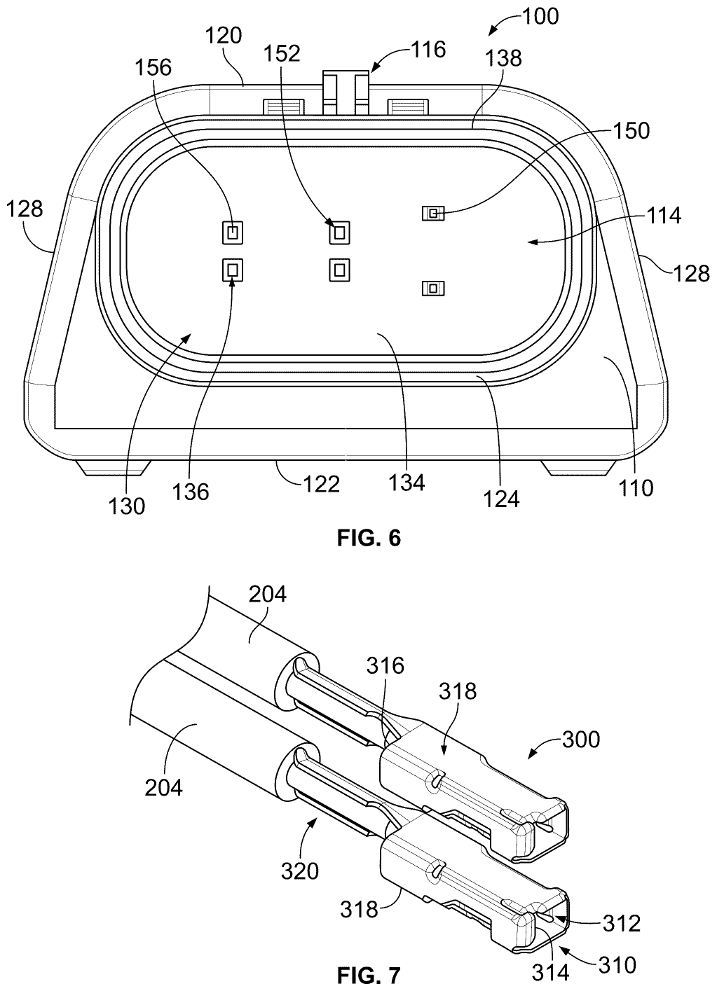

FIG. 4 is a bottom perspective view of the header connector 100 in accordance with an exemplary embodiment. FIG. 5 is a rear view of the header connector 100 in accordance with an exemplary embodiment. FIG. 6 is a front view of the header connector 100 in accordance with an exemplary embodiment.

In an exemplary embodiment, the header housing 110 includes a latching element 116 for latchably coupling the plug connector 200 to the header connector 100. In the illustrated embodiment, the latching element 116 is located along the top of the header housing 110. Other locations are possible in alternative embodiments. In various embodiments, the latching element 116 is a catch element having a catch surface configured to receive a latch of the plug connector 200. Other types of latching elements may be used in alternative embodiments. For example, the latching element 160 may include a deflectable latch configured to be latchably coupled to the plug connector 200.

The header housing 110 extends between a top 120 and a bottom 122. The header housing 110 extends between a front 124 and a rear 126. The header housing 110 includes sides 128 between the top 120 and the bottom 122 and/or between the front 124 and the rear 126. In an exemplary embodiment, the header housing 110 includes a mating end 130 configured for mating with the plug connector 200. In the illustrated embodiment, the mating end 130 is located at the front 124. Other locations are possible in alternative embodiments. In an exemplary embodiment, the header housing 110 includes a mounting end 132 configured to be mounted to the circuit board 102 (FIG. 1). In the illustrated embodiment, the mounting end 132 is located at the bottom 122 and/or at the rear 126.

In an exemplary embodiment, the header housing 110 includes an end wall 134. The end wall 134 may extend between the sides 128. The end wall 134 may extend between the top 120 and the bottom 122. In an exemplary embodiment, the end wall 134 holds the header contacts 150. For example, the end wall 134 includes contact channels 136 that receive the header contacts 150. In an exemplary embodiment, the receptacle 114 is located forward of the end wall 134. The header contacts 150 extend from the end wall 134 into the receptacle 114. The header contacts 150 may extend from the end wall 134 to the mounting end 132 for connection to the circuit board 102.

In an exemplary embodiment, the header housing 110 includes a shroud 138 extending forward of the end wall 134. The shroud 138 forms a nose cone at the front 124. The shroud 138 surrounds and/or defines the receptacle 114. The shroud 138 surrounds ends of the header contacts 150, such as to protect the header contacts 150. The shroud 138 may be oval-shaped, such as being elongated side to side. In other embodiments, the shroud 138 may be rectangular shaped. The shroud 138 may have other shapes in alternative embodiments. In an exemplary embodiment, the shroud 138 is configured be received in the plug connector 200 and is configured to be sealed to the plug connector 200.

In an exemplary embodiment, the header housing 110 includes a mounting bracket 140 at the mounting end 132. The mounting bracket 140 is configured to be mounted to the circuit board 102. In an exemplary embodiment, the mounting bracket 140 includes one or more mounting legs 142 used to support the header housing 110 on the circuit board 102. The mounting legs 142 may extend rearward from the mounting bracket 140 and/or the end wall 134. In an exemplary embodiment, the mounting bracket 140 includes one or more mounting posts 144 configured be received in corresponding openings in the circuit board 102. The mounting posts 144 may extend downward from the mounting legs 142. The mounting posts 144 provide alignment of the header housing 110 to the circuit board 102. The mounting posts 144 may provide mechanical retention to the circuit board 102. For example, the mounting posts 144 may have a split beam designed configured to be held in the opening of the circuit board 102 by a spring fit or interference fit. In an exemplary embodiment, the mounting bracket 140 may include a mounting flange 146 configured be mounted to a panel, a wall, or other mounting structure. For example, a front surface or a rear surface of the mounting flange 146 may abut against the mounting structure. The mounting flange 146 may extend outward from the end wall 134 and/or the mounting bracket 140. The mounting flange 146 may extend outward from the top 120 and/or the bottom 122 and/or the sides 128. In various embodiments, the mounting flange 146 may extend entirely circumferentially around the header housing 110.

The header contacts 150 are configured to be mated with the plug connector 200. The header contacts 150 are configured to be connected to the circuit board 102. In an exemplary embodiment, the header contacts 150 are stamped and formed contacts. The header contacts 150 may be right angle contacts, such as having a 90° bend. The header contacts 150 may have other shapes in alternative embodiments. One or more of the header contacts 150 may be power contacts. One or more of the header contacts 150 may be ground contacts. One or more of the header contacts 150 may be signal contacts. Optionally, the signal contacts may be arranged in pairs. The header contacts 150 may be arranged in rows and/or columns within the header housing 110. In the illustrated embodiment, the header contacts 150 are vertically offset in pairs across the header housing 110, such as in three sets.

In an exemplary embodiment, each header contact 150 extends between a mating end 152 and a terminating end 154. The header contact 150 transitions between the mating end 152 and the terminating end 154. Optionally, the transition may include bends or jogged portions to account for contact length skew of the overall lengths of the header contacts 150.

The mating end 152 is configured to be mated with the plug connector 200. In the illustrated embodiment, the mating end 152 includes a mating pin 156. The mating pin 156 may be a square pin or a cylindrical pin. The mating pin 156 may have other shapes in alternative embodiments. In other various embodiments, the mating end 152 may include a different type of interface, such as a socket contact, a spring beam, or other type of mating contact.

The terminating end 154 is configured to be terminated to the circuit board 102. In the illustrated embodiment, the terminating end 152 includes a solder tail 158 configured to be received in a plated via of the circuit board 102. Alternatively, the solder tail 158 may be bent 90° for surface mounting to a pad of the circuit board 102. In other various embodiments, the terminating end 154 may include a different type of interface, such as a compliant pin, a press-fit pin, a solder pad, a solder ball, a spring beam, or other type of contact.

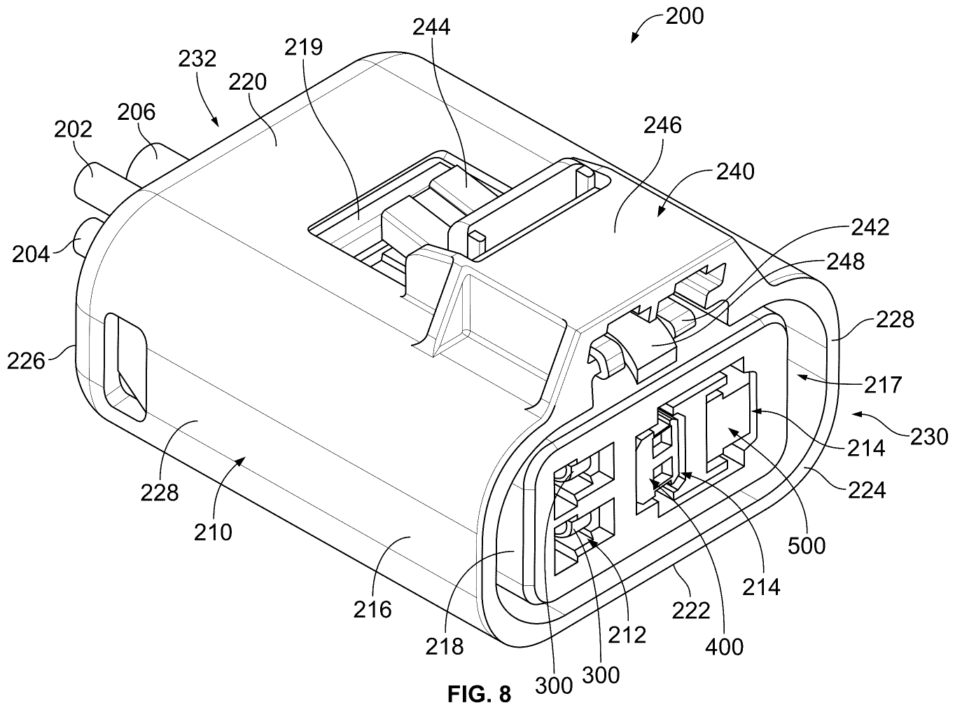

FIG. 7 is a perspective view of a portion of the plug connector 200 showing a pair of the power contacts 300 in accordance with an exemplary embodiment. The power contacts 300 are terminated to ends of the power cables 204. In the illustrated embodiment, the power contacts 300 are crimped to the power cables 204. In alternative embodiments, the power contacts 300 may be welded or soldered to the power cables 204. The power contacts 300 may be arranged in a vertical stack, such as above and below each other. One of the power contacts 300 may be a positive contact in the other of the power contacts 300 may be a negative contact. Optionally, the negative contact may be referenced to ground.

In an exemplary embodiment, the power contact 300 is a stamped and formed contact. Each power contact 300 extends between a mating end 310 and a terminating end 320. The mating end 310 is configured to be mated with the corresponding header contact 150 of the header connector 100. The terminating end 320 is configured to be terminated to the end of the power cable 204. In the illustrated embodiment, the mating end 310 includes a socket 312. For example, the mating end 310 may include four walls forming a box shaped socket 312. The mating end 310 includes a mating beam 314 extending into the socket 312 to electrically connect to the header contact 150. Other types of mating interfaces may be provided at the mating end 310 in alternative embodiments, such as a pin, a spring beam, or other types of mating interface.

In an exemplary embodiment, the mating end 310 includes a stop surface 316 configured to interface with a primary latch of the plug housing of the plug connector 200 to retain the power contacts 300 in the plug housing. The stop surface 316 may be located at the rear of the mating end 310. The stop surface 316 may be rearward facing to prevent pullout of the power contact 300 from the plug housing.

In an exemplary embodiment, the power contact 300 includes an interface surface 318. The interface surface 318 may be located along a side of the mating end 310 of the power contact 300, such as along the top, the bottom, or one of the side edges. The mating surface 318 may be planar. The mating surface 318 is configured to interface with a jumper contact to provide electrical connection to another component, such as the end node termination module 500.

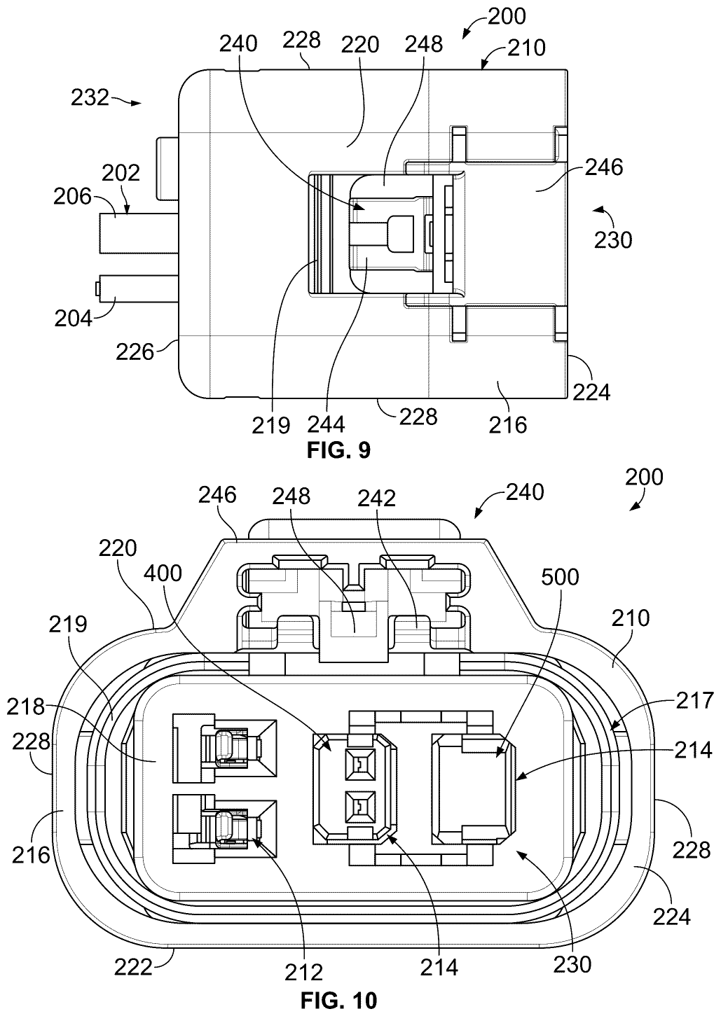

FIG. 8 is a front perspective view of the plug connector 200 in accordance with an exemplary embodiment. FIG. 9 is a top view of the plug connector 200 in accordance with an exemplary embodiment. FIG. 10 is a front view of the plug connector 200 in accordance with an exemplary embodiment. The plug connector 200 includes the plug housing 210, the power contacts 300, the data module 400, and the end node termination module 500. Other arrangements are possible in alternative embodiments, such as having multiple data modules 400.

In an exemplary embodiment, the plug housing 210 is a multipiece housing including an outer housing 216 and an inner housing 218 coupled to the outer housing 216. The outer housing 216 surrounds the inner housing 218 forming a housing well 217 between the inner housing 218 and the outer housing 216. The housing well 217 is configured to receive the shroud 138 of the header housing 110. In an exemplary embodiment, a housing seal 219 is located in the housing well 217 to interface with the shroud 138 when the plug connector 200 is mated with the header connector 100. The housing seal 219 provides a sealed between the plug housing 210 and the header housing 110. The outer housing 216 may surround the shroud 138 of the header housing 110. The inner housing 218 is configured to be plugged into the receptacle 114 of the header housing 110. While the outer housing 216 and the inner housing 218 are separate housing structures configured to be coupled together, it is realized that the outer housing 216 and the innerhousing 218 may be integral structures in alternative embodiments. For example, the outer housing 216 and the inner housing 218 may be co-molded to form a unitary, monolithic or single piece housing.

The plug housing 210 extends between a top 220 and a bottom 222. The plug housing 210 extends between a front 224 and a rear 226. The plug housing 210 includes sides 228 between the top 220 and the bottom 222 and/or between the front 224 and the rear 226. In an exemplary embodiment, the plug housing 210 includes a mating end 230 configured for mating with the header connector 100. In the illustrated embodiment, the mating end 230 is located at the front 224. Other locations are possible in alternative embodiments. In an exemplary embodiment, the plug housing 210 includes a cable end 232 where the cables 202 enter/exit the plug housing 210. In the illustrated embodiment, the cable end 232 is located at the rear 226. Other locations are possible in alternative embodiments.

In an exemplary embodiment, the inner housing 218 includes the power contact channels 212 in the module channels 214. The inner housing 218 holds the power contacts 300, the data module 400, and the end node termination module 500. The power contact channels 212 and the module channels 214 are open at the mating end 230 (for example, the front 224) to provide access for mating with the header connector 100. In an exemplary embodiment, the power contact channels 212 and the module channels 214 are open at the rear 226 for loading the power contacts 300 into the power contact channels 212 and loading the data module 400 and the end node termination module 500 into the module channels 214. The power cables 204 and the data cables 206 extend from the power contact channels 212 and the module channels 214 at the cable end 232 (for example, the rear 226).

In an exemplary embodiment, the plug housing 210 includes a latching element 240 configured to be latchably coupled to the header connector 100. In the illustrated embodiment, the latching element 240 is located at the top 220. Other locations are possible in alternative embodiments. The latching element 240 includes a deflectable latch 242 that is movable between a latched position and an unlatched position. In an exemplary embodiment, the deflectable latch 242 includes an actuator 244 that may be pressed or actuated to move the latch 242 between the latched position and the unlatched position. In the illustrated embodiment, the latching element 240 includes a latch cover 246 covering the deflectable latch 242. In an exemplary embodiment, the latching element 240 includes a latch lock 248 that may be moved from an unlocked position and a locked position. For example, the latch lock 248 may be slid along the plug housing 210, such as front to rear or side to side between the unlocked position and the locked position. When the latch lock 248 is in the locked position, the latch lock 248 prevents movement of the latch 242 (for example, to the unlatched position). The latch lock 248 may define a position assurance device used to assure positioning of the latch 242 and/or to ensure proper positioning of the plug connector 200 and the header connector 100 in a mated condition. For example, the latch lock 248 may be movable to the locked position only when the plug connector 200 is properly mated with the header connector 100.

In the illustrated embodiment, the data module 400 is located at a central location at the mating end 230 of the plug housing 210. The power contacts 300 are located at a first side of the data module 400 and the end node termination module 500 is located at the opposite second side of the data module 400. Other arrangements are possible in alternative embodiments. In an exemplary embodiment, the end node termination module 500 may be electrically connected to the data module 400 and/or one or more of the power contacts 300. For example, internal contacts or connections may be made between the end node termination module 500 and the data module 400 and/or the power contacts 300 to allow signal processing within the plug connector 200. For example, the end node termination module 500 may perform common mode signal processing, differential mode signal processing, or other types of signal processing onboard within the plug connector 200. As such, the signal processing does not need to occur on the circuit board 102 associated with the header connector 100, thus saving real estate on the circuit board 102 and/or reducing the size of the circuit board 102.

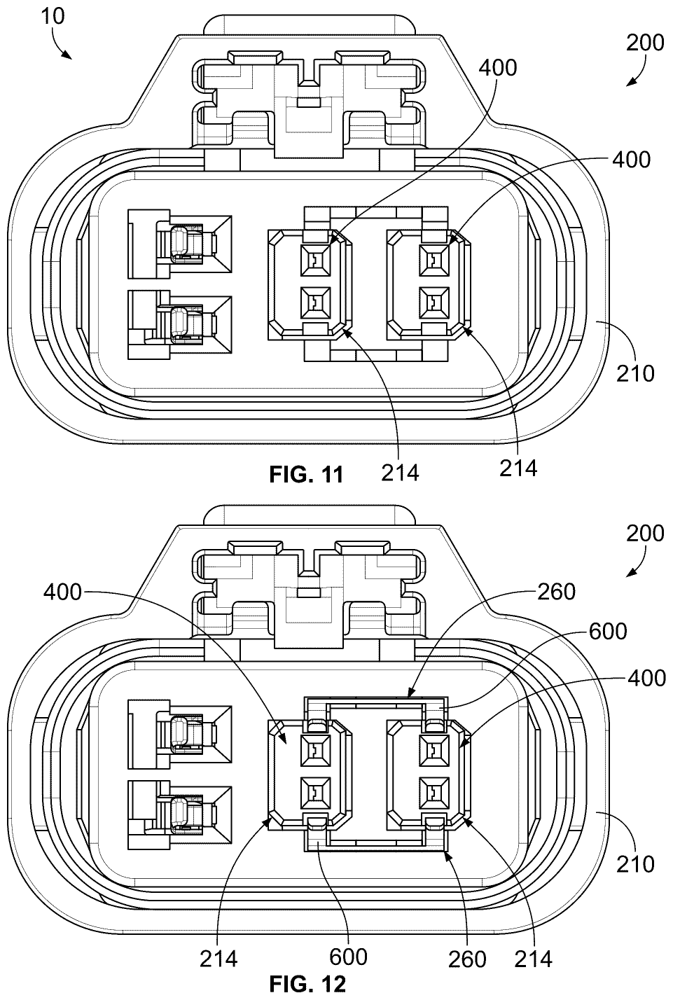

FIG. 11 is a front view of the plug connector 200 in accordance with an exemplary embodiment. In the illustrated embodiment, the plug connector 200 includes a pair of the data modules 400 arranged in the corresponding module channel 214, but does not include the end node termination module 500. In an exemplary embodiment, the plug connector 200 is modular in design allowing configuration of the plug connector 200 by interchanging components to achieve the desired configuration. The same plug housing 210 may be used in the various configurations, thus saving design and manufacturing costs of the electrical connector system 10 by utilizing the same components across multiple platforms.

FIG. 12 is a front view of the plug connector 200 in accordance with an exemplary embodiment. In the illustrated embodiment, the plug connector 200 includes a pair of the data modules 400 arranged in the corresponding module channels 214, and includes jumper contacts 600 electrically connecting the data modules 400. The jumper contacts 600 are arranged in jumper contact channels 260 of the plug housing 210. The jumper contacts 600 extend into the module channels 214 to interface with the data modules 400.

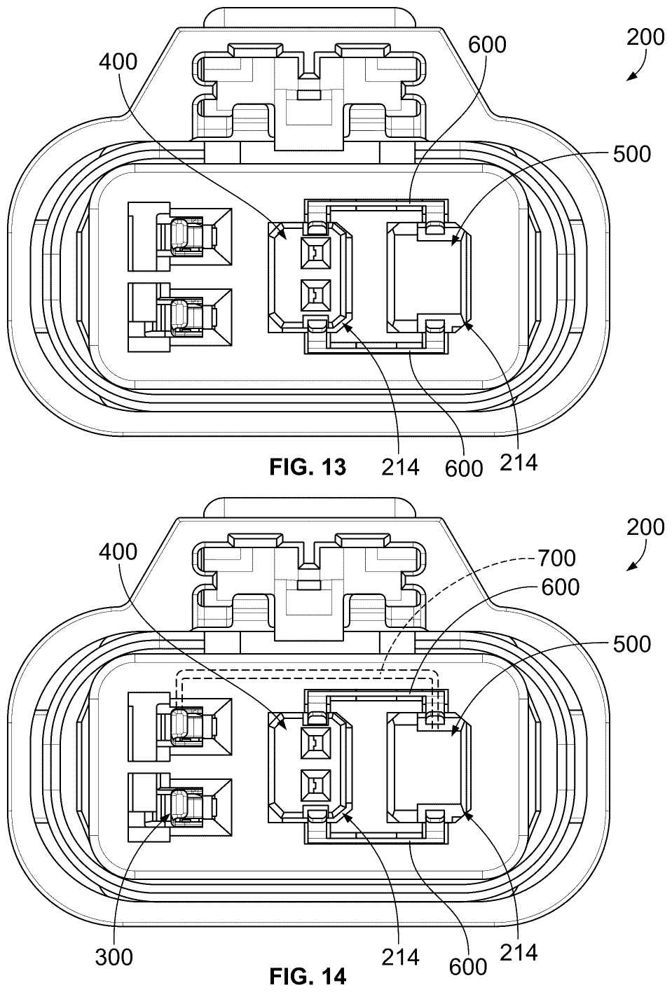

FIG. 13 is a front view of the plug connector 200 in accordance with an exemplary embodiment. In the illustrated embodiment, the plug connector 200 includes the data module 400 and the end node termination module 500 arranged in the corresponding module channels 214. The plug connector 200 includes the jumper contacts 600 electrically connecting the data module 400 with the end node termination module 500. The end node termination module 500 is able to process the signals from the data module 400 by connecting to the signals of the data module 400. In an exemplary embodiment, the end node termination module 500 may provide differential mode end node signal processing.

FIG. 14 is a front view of the plug connector 200 in accordance with an exemplary embodiment. In the illustrated embodiment, the plug connector 200 includes the data module 400 and the end node termination module 500 arranged in the corresponding module channels 214. The plug connector 200 includes the jumper contacts 600 electrically connecting the data module 400 with the end node termination module 500. The plug connector 200 includes a ground jumper contact 700 electrically connecting the end node termination module 500 to a grounded component of the plug connector 200. In an exemplary embodiment, the grounded component of the plug connector 200 is 1 of the power contacts 300 that is connected to the ground reference (for example, the negative power terminal). The end node termination module 500 is able to process the signals from the data module 400 by connecting to the signals of the data module 400 and to the ground reference. In an exemplary embodiment, the end node termination module 500 may provide common mode end node signal processing.

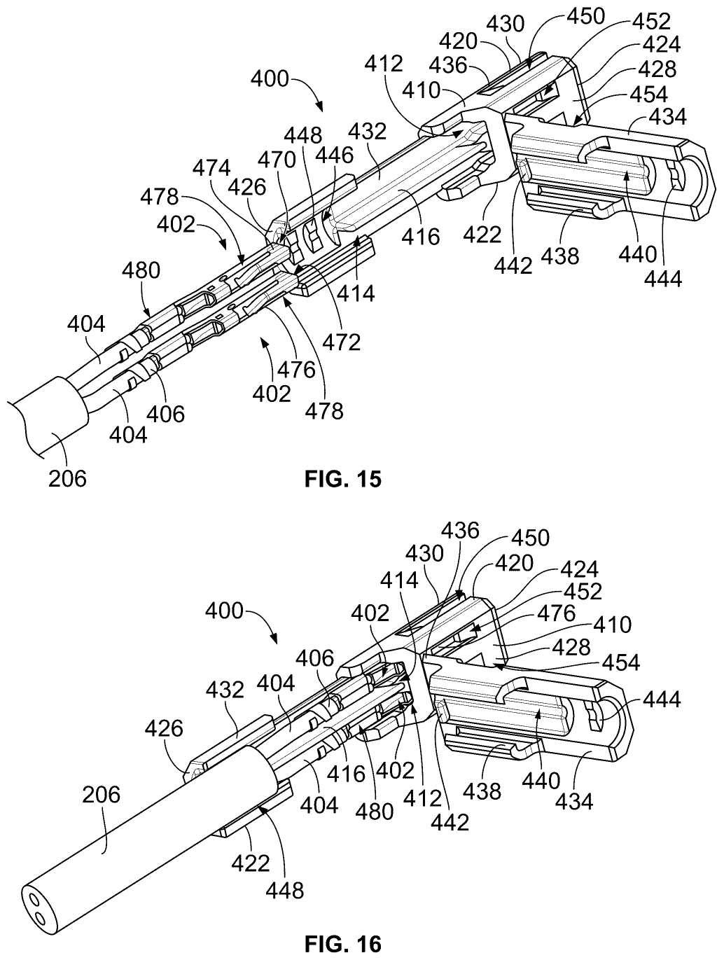

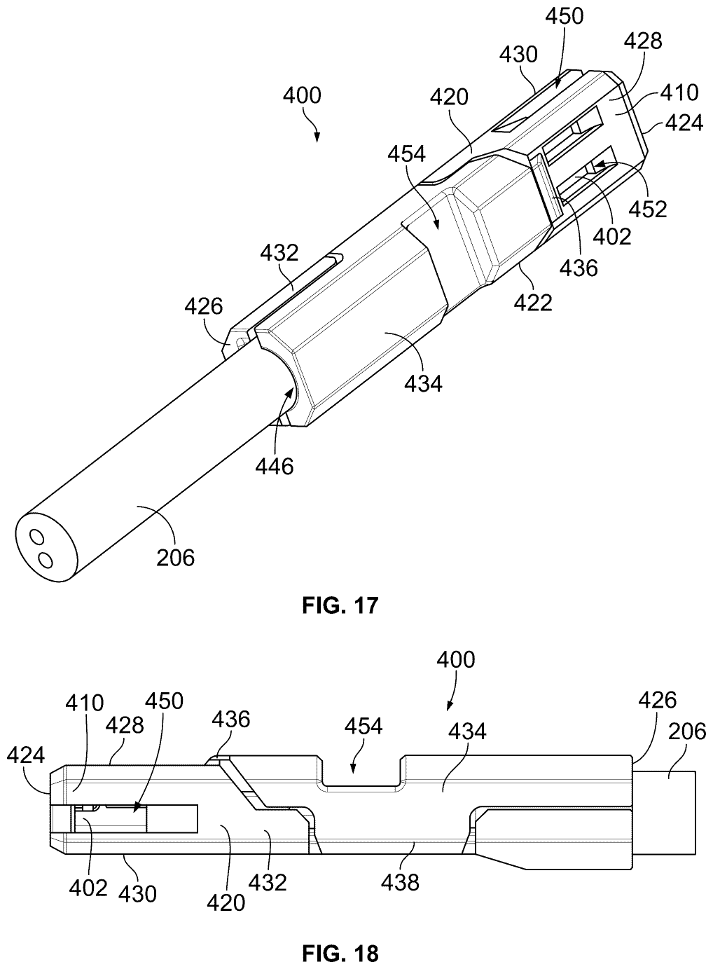

FIG. 15 is an exploded view of the data module 400 in accordance with an exemplary embodiment. FIG. 16 is a partially assembled view of the data module 400 in accordance with an exemplary embodiment. FIG. 17 is an assembled view of the data module 400 in accordance with an exemplary embodiment. FIG. 18 is a side view of the data module 400 in accordance with an exemplary embodiment.

The data module 400 includes a data module housing 410 configured to hold signal contacts 402 and the data cable 206. In the illustrated embodiment, the data cable 206 includes signal wires 404 surrounded by an insulator 406, such as a cable jacket. In an exemplary embodiment, the signal wires 404 are a twisted-pair of signal wires. In an exemplary embodiment, the signal wires 404 are an unshielded twisted pair of signal wires. The signal contacts 402 are terminated to ends of the signal wires 404. For example, the signal contacts 402 may be crimped to ends of the signal wires 404. In an exemplary embodiment, a portion of the insulator 406 is stripped to expose ends of the signal wires 404. A length of the signal wires 404 are untwisted forward of the insulator 406 for termination to the signal contacts 402. The untwisted length of the signal wires 404 may be kept relatively short for signal integrity along the signal transmission lines.

In an exemplary embodiment, the signal contacts 402 are stamped and formed contacts. Each signal contact 402 extends between a mating end 470 and a terminating end 480. The mating end 470 is configured to be mated with the corresponding header contact 150 of the header connector 100. The terminating end 480 is configured to be terminated to the end of the corresponding signal wire 404. In an exemplary embodiment, the terminating end 480 includes a crimp barrel configured to be crimped to the end of the corresponding signal wire 404. Other types of terminations may be used in alternative embodiments, such as soldering, welding, insulation displacement connections, and the like. In an exemplary embodiment, one of the signal contacts 402 may form a positive signal transmission line while the other of the signal contacts 402 may form a negative signal transmission line. The signal contacts 402 may transmit differential mode signals. In other various embodiments, the signal contacts 402 may transmit common mode signals.

In the illustrated embodiment, the mating end 470 includes a socket 472. For example, the mating end 470 may include four walls forming a box shaped socket 472. The mating end 470 includes one or more mating beams 474 extending into the socket 472 to electrically connect to the header contact 150. In an exemplary embodiment, the mating end 470 includes a latch 476 configured to be latchably coupled to the data module housing 410 to retain the signal contact 402 in the data module housing 410. Alternatively, the mating end 470 may include a stop surface configured to interface with the primary latch extending from the data module housing 410. Other types of mating interfaces may be provided at the mating end 470 in alternative embodiments, such as a pin, a spring beam, or other types of mating interface.

In an exemplary embodiment, the signal contact 402 includes an interface surface 478. The interface surface 478 may be located along a side of the mating end 470 of the signal contact 402, such as along the top, the bottom, or one of the side edges. The mating surface 478 may be planar. The mating surface 478 is configured to interface with the corresponding jumper contact 600 (FIG. 12) to provide electrical connection to another component, such as the end node termination module 500.

The data module housing 410 includes contact channels 412 and associated wire channels 414. The contact channels 412 receive the corresponding signal contacts 402. The wire channels 414 receive the corresponding signal wires 404. The wire channels 414 are separated by a partition wall 416 that separates the signal wires 404 from each other. The partition wall 416 may extend all the way to the insulator 406 to separate the parallel portions of the signal wires 404 forward of the twisted portions of the signal wires 404. The partition wall 416 controlled impedance and other electrical characteristics of the signal transmission lines along parallel portions of the signal wires 404 as the signal wires 404 transition to the signal contacts 402. The partition wall 416 continues between the contact channels 412 to separate the signal contacts 402 from each other.

The data module housing 410 extends between a top 420 and a bottom 422. The data module housing 410 extends between a front 424 and a rear 426. The data module housing 410 includes a first side 428 and a second side 430. The front 424 defines a mating end of the data module housing 410 configured for mating with the header connector 100. The data cable 206 enters/exits the data module housing 410 at the rear 426.

In an exemplary embodiment, the data module housing 410 is a multipiece housing including a main body 432 and a cover 434 configured to be coupled to the main body 432 to close the contact channels 412 in the wire channels 414 after the signal contacts 402 in the signal wires 404 are loaded into the data module housing 410. In the illustrated embodiment, the cover 434 is located at the first side 428. In an exemplary embodiment, the cover 434 is formed integral with the main body 432, such as being connected by a living hinge 436. For example, the cover 434 and the main body 432 may be co-molded during a single injection molding process. The cover 434 may be coupled to the main body 432 by rotating the cover 434 to a closed position. In alternative embodiments, the cover 434 may be separately manufactured from the main body 432 and coupled thereto.

Securing features 438 are provided to secure the cover 434 to the main body 432, such as latches, clips, fasteners, or other types of securing features. In the illustrated embodiment, the securing features 438 include latching arms extending from the top and the bottom of the cover 434 configured be latchably coupled to the top and the bottom of the main body 432.

In an exemplary embodiment, the cover 434 includes a groove 440 that receives the distal end of the partition wall 416. The groove 440 and the partition wall 416 may be used to position the cover 434 relative to the main body 432.

In an exemplary embodiment, the cover 434 includes tabs 442 that extend from the interior of the cover 434. The tabs 442 are configured to interface with the signal contacts 402 and/or the signal wires 404 to load the signal contacts 402 or the signal wires 404 into the contact channels 412 or the wire channels 414, respectively. The tabs 442 may be used to hold side to side and/or front to rear positions of the signal contacts 402 and/or the signal wires 404 in the data module housing 410. For example, the tabs 442 may prevent pullout of the signal contacts 402 from the contact channels 412.

In an exemplary embodiment, the cover 434 includes a retention rib 444 configured to interface with the data cable 206. For example, the retention rib 444 may interface with the insulator 406 (for example, the cable jacket) when the cover 434 is coupled to the main body 432. The retention rib 444 may slightly dig into the material of the insulator 406 to lock the insulator 406 in the data module housing 410, such as to provide strain relief and/or prevent pullout of the data cable 206 from the data module housing 410. The retention rib 444 is sized/shaped for retention but is designed to not damage the wire. The data module 400 may be used with unjacketed cables, in which case the retention rib 444 may engage the conductor or the retention rib 444 may not be used for wire retention.

In an exemplary embodiment, the main body 432 includes a cable pocket 446 at the rear 426. The cable pocket 446 receives the end of the data cable 206. The cable pocket 446 may receive the insulator 406. In an exemplary embodiment, the main body 432 includes one or more retention ribs 448 extending into the cable pocket 446. The retention ribs 448 are configured to interface with the data cable 206. For example, the retention ribs 448 may interface with the insulator 406 (for example, the cable jacket) when the cover 434 is coupled to the main body 432. The retention ribs 448 may slightly dig into the material of the insulator 406 to lock the insulator 406 in the data module housing 410, such as to provide strain relief and/or prevent pullout of the data cable 206 from the data module housing 410. The retention ribs 448 are sized/shaped for retention but designed to not damage the wire.

In an exemplary embodiment, the data module housing 410 includes access windows 450. The access windows 450 provide access to the contact channels 412. The access windows 450 provide access to the socket contacts 402 in the contact channels 412 for the jumper contacts 600. In the illustrated embodiment, the access windows 450 are located at or near the front 424 to allow access to the signal contacts 402. In the illustrated embodiment, the access windows 450 are located at the top 420 and the bottom 422 to access both of the signal contacts 402 at the top and the bottom of the data module housing 410. The access windows 450 may be provided at other locations in alternative embodiments.

In an exemplary embodiment, the data module housing 410 includes latch openings 452 that receive the latches 476 of the signal contacts 402. In the illustrated embodiment, the latch openings 452 are provided at the first side 428. Other locations are possible in alternative embodiments. When the signal contacts 402 are loaded into the data module housing 410, the latches 476 may spring outward into the latch openings 452 to secure the signal contacts 402 in the contact channels 412. The latches 476 may prevent pullout of the signal contacts 402 from the contact channels 412.

In an exemplary embodiment, the data module housing 410 includes a locking slot 454 configured to receive a locking element used to secure the data module 400 in the plug housing 210. In the illustrated embodiment, the locking slot 454 is a notch formed in one of the sides of the data module housing 410. For example, the locking slot 454 may be formed in the cover 434. The locking slot 454 may be located along the first side 428. Other locations are possible in alternative embodiments. The locking slot 454 may be open at the top 420 and/or the bottom 422 to receive the locking element.

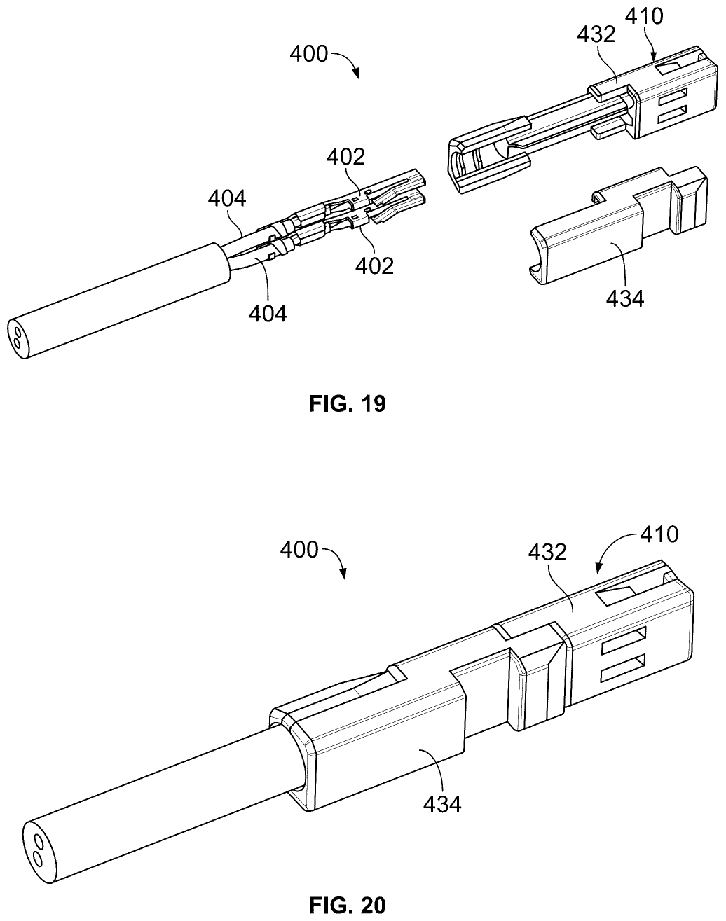

FIG. 19 is an exploded view of the data module 400 in accordance with an exemplary embodiment. FIG. 20 is an assembled view of the data module 400 in accordance with an exemplary embodiment. FIGS. 19 and 20 illustrate the data module housing 410 as a two-piece housing with the cover 434 separate and discrete from the main body 432. The cover 434 is configured to be coupled to the side of the main body 432 after the signal contacts 402 and the signal wires 404 are loaded into the data module housing 410.

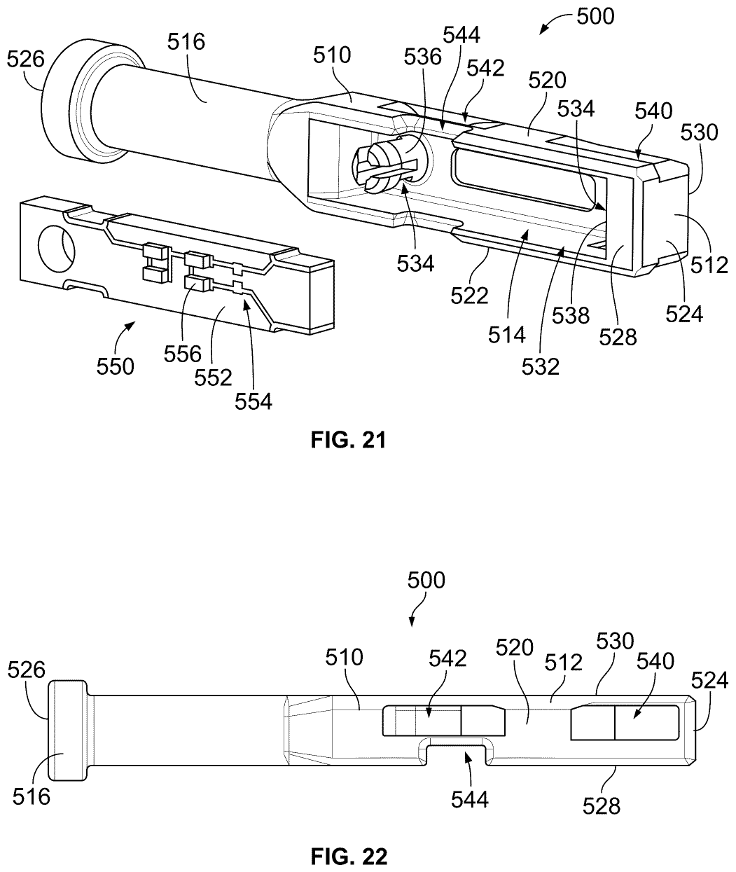

FIG. 21 is an exploded view of the end node termination module 500 in accordance with an exemplary embodiment. The end node termination module 500 includes a termination module housing 510 and a signal processing assembly 550 held by the termination module housing 510. In an exemplary embodiment, the signal processing assembly 550 includes an end node printed circuit board (PCB) 552 having one or more end node control circuits 554 with one or more signal processing components 556 for controlling the end node control circuit 554.

With additional reference to FIG. 22, which is a top view of the termination module housing 510, the termination module housing 510 includes a main body 512 having a pocket 514 that receives the signal processing assembly 550. For example, the end node PCB 552 and the corresponding signal processing components 556 are configured to be received in the pocket 514. In an exemplary embodiment, the termination module housing 510 includes a handle 516 extending from the main body 512. The handle 516 is used for loading and unloading the end node termination module 500 into and out of the plug housing 210. The handle 516 plugs the cable hole for the channel in the plug housing 210, such as to provide sealing for the channel.

In an exemplary embodiment, the termination module housing 510 is dimensionally similar to the data module housing 410 (FIG. 15) to allow interchangeable loading of the end node termination module 500 and the data module 400 into the module channels 214 of the plug housing 210. The termination module housing 510 may include similar features as the data module housing 410, such as positioning features, securing features, and the like for positioning and securing the end node termination module 500 and the data module 400 in the module channels 214 of the plug housing 210.

The termination module housing 510 extends between a top 520 and a bottom 522. The termination module housing 510 extends between a front 524 and a rear 526. The termination module housing 510 includes a first side 528 and a second side 530. The front 524 defines a connecting end of the termination module housing 510 configured for connecting to the jumper contacts 600 and/or the ground jumper contact 700. The handle 516 is located at the rear 526.

In an exemplary embodiment, the termination module housing 510 includes a loading opening 532 at the first side 528. The signal processing assembly 550 is configured to be loaded into the pocket 514 through the loading opening 532. The loading opening 532 is open at the first side 528. Other locations are possible in alternative embodiments.

In an exemplary embodiment, the termination module housing 510 includes one or more fixation features 534 for fixing the signal processing assembly 550 in the pocket 514. In an exemplary embodiment, the fixation features 534 include a post 536 located in the pocket 514. The end node PCB 552 may be coupled to the post 536. The post 536 may position the end node PCB 552 front to rear and/or side-to-side. In the illustrated embodiment, the post 536 is located near a rear portion of the pocket 514. Other locations are possible in alternative embodiments. The post 536 may provide mechanical retention to the end node PCB 552. For example, the post 536 may have a split beam designed configured to be held in an opening of the end node PCB 552 by a spring fit or interference fit. In an exemplary embodiment, the fixation features 534 include a capture wall 538 configured to capture an end of the end node PCB 552. The capture wall 538 may be located near the front 524. During assembly, the front end of the end node PCB 552 may be loaded into the pocket 514 behind the capture wall 538 to capture the front end of the end node PCB 552 while the rear end of the end node PCB 552 is coupled to the post 536. As such, the front and rear portions of the end node PCB 552 are held in the pocket 514 by the fixation features 534. Other types of fixation features may be used in alternative embodiments.

In an exemplary embodiment, the termination module housing 410 includes access windows 540. The access windows 540 provide access to the signal processing assembly 550 in the pocket 514. The access windows 540 provide access to portions of the end node PCB 552 in the pocket 514 for the jumper contacts 600. In the illustrated embodiment, the access windows 540 are located at or near the front 424. In the illustrated embodiment, the access windows 540 are located at the top 420 and the bottom 422 to access both the top and bottom edges of the end node PCB 552 at the top and the bottom of the termination module housing 410. The access windows 540 may be provided at other locations in alternative embodiments.

In an exemplary embodiment, the termination module housing 410 includes one or more ground access windows 542. The ground access window 542 provides access to the signal processing assembly 550 in the pocket 514. The ground access window 542 provides access to a portion of the end node PCB 552 in the pocket 514 for the ground jumper contacts 700. In the illustrated embodiment, the ground access window 542 is located at the top 420. The ground access window 542 may be provided at other locations in alternative embodiments.

In an exemplary embodiment, the termination module housing 510 includes a locking slot 544 configured to receive a locking element used to secure the termination module 500 in the plug housing 210. In the illustrated embodiment, the locking slot 544 is a notch formed in one of the sides of the termination module housing 510. For example, the locking slot 544 may be located along the first side 528. Other locations are possible in alternative embodiments. The locking slot 544 may be open at the top 520 and/or the bottom 522 to receive the locking element.

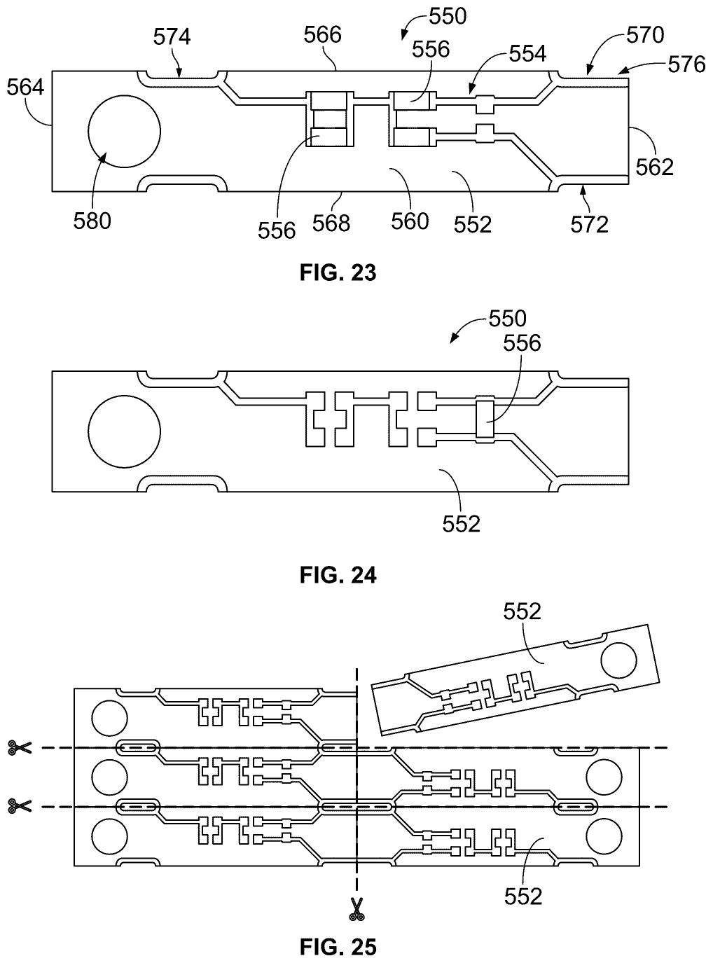

FIG. 23 illustrates the signal processing assembly 550 in accordance with an exemplary embodiment. The signal processing assembly 550 includes the end node PCB 552, the end node control circuit 554, and the signal processing component 556.

The end node PCB 552 includes a substrate having surfaces 560 at opposite sides of the substrate. The end node PCB 552 may be manufactured by conventional circuit board manufacturing processes. The end node PCB 552 includes circuits printed on one or more layers of the substrate, such as at the outer surface 560. The circuits may be traces, pads, vias, or other conductive elements forming circuit patterns on one or more layers of the substrate. The end node PCB 552 includes a front edge 562, a rear edge 564, a first edge 566 (for example, top edge) between the front and rear edges 562, 564, and a second edge 568 (for example, bottom edge) between the front and rear edges 562, 564. In an exemplary embodiment, the signal processing components 556 are mounted to the corresponding circuits at the surface 560 of the end node PCB 552 to form the end node control circuit 554.

In an exemplary embodiment, the end node PCB 552 includes a first signal edge pad 570 at the first edge 566 and a second signal edge pad 572 at the second edge 568. In an exemplary embodiment, the end node PCB 552 includes a ground edge pad 574 along the first edge 566 or the second edge 568. Additional signal edge pads and/or ground edge pads may be provided along the first edge 566 and/or the second edge 568. The first signal edge pad 570 may be a positive signal conductor configured be electrically connected to the positive signal transmission line of the data module 400. The second signal edge pad 572 may be a negative signal conductor configured to be electrically connected to the negative signal transmission line of the data module 400.

In an exemplary embodiment, the end node PCB 552 includes notches 576 along the first and second edges 566, 568. The signal edge pads 570, 572 and/or the ground edge pad 574 may be located in the notches 576 such that the edge pads are recessed relative to the edges 566, 568. The notches 576 may be formed in the end node PCB 552 to form a space for plating the edges 566, 568 to form the edge pads 570, 572, 574.

In an exemplary embodiment, the signal edge pads 570, 572 may span across one or more of the layers of the end node PCB 552. For example, the signal edge pads 570, 572 may span the width of the first edge 566 or the second edge 568, respectively, between the opposite surfaces 560 of the end node PCB 552. A portion of the first signal edge pad 570 may transition over to the surface 560 and connect to one or more traces on the surface 560. A portion of the second signal edge pad 572 may transition over to the surface 560 and connect to one or more traces on the surface 560. In an exemplary embodiment, the ground edge pad 574 may span across one or more the layers of the end node PCB 552. For example, the ground edge pad 574 may span the width of the first edge 566 or the second edge 568 between the opposite surfaces 560 of the end node PCB 552. A portion of the ground edge pad 574 may transition over to the surface 560 and connect to one or more traces on the surface 560.

The first and second signal edge pads 570, 572 are configured to be electrically connected to corresponding signal processing components 556, such as by traces or other conductive circuits of the end node PCB 552. The signal processing components 556 perform signal processing for the signals transmitted via the signal edge pads 570, 572 to/from the jumper contacts 600. The signal processing components 556 perform signal processing for the signal processing assembly 550. The signal processing components 556 may include transistors, resistors, capacitors, diodes, integrated circuits, op-amps, filters, microprocessors, microcontrollers, oscillators, switches, transformers, switches, relays, or other types of electrical components for performing signal processing. The signal processing components 556 may be active components and/or passive components. The signal processing components 556 may be electrically connected to the first signal edge pad 570, the second signal edge pad 572, or both the first and second signal edge pads 570, 572. The signal processing components 556 may additionally or alternatively be connected to the ground edge pad 574.

In an exemplary embodiment, the end node PCB 552 includes an opening 580. The opening 580 may be used as a locating feature and/or a securing feature for positioning the end node PCB 552 in the termination module housing 510. For example, the opening 580 may receive the post 536 to position the end node PCB 552 in the pocket 514 of the termination module housing 510. In the illustrated embodiment, the opening 580 is located near the rear of the end node PCB 552. Other locations are possible in alternative embodiments. The opening 580 passes through the end node PCB 552 between the surfaces 560.

FIG. 24 illustrates the signal processing assembly 550 in accordance with an exemplary embodiment. FIG. 24 shows a different arrangement of the signal processing components 556 on the end node PCB 552 compared to the embodiment shown in FIG. 23. The arrangement of the signal processing components 556 in FIG. 24 perform a different type of signal processing than the arrangement of the signal processing components 556 in FIG. 23. For example, FIG. 24 is used for differential mode signal processing, whereas FIG. 23 is used for common mode signal processing. In an exemplary embodiment, the same end node PCB 552 is utilized in both arrangements allowing manufacture of a single end node PCB 552 for use in different applications. Other arrangements of the signal processing components 556 may be used in alternative embodiments for other types of signal processing.

FIG. 25 illustrates a plurality of the end node PCBs 552 during manufacture in accordance with an exemplary embodiment. The end node PCBs 552 are manufactured as part of a common circuit board structure and the individual end node PCBs 552 are singulated or separated from the structure. Other manufacturing techniques may be used in alternative embodiments.

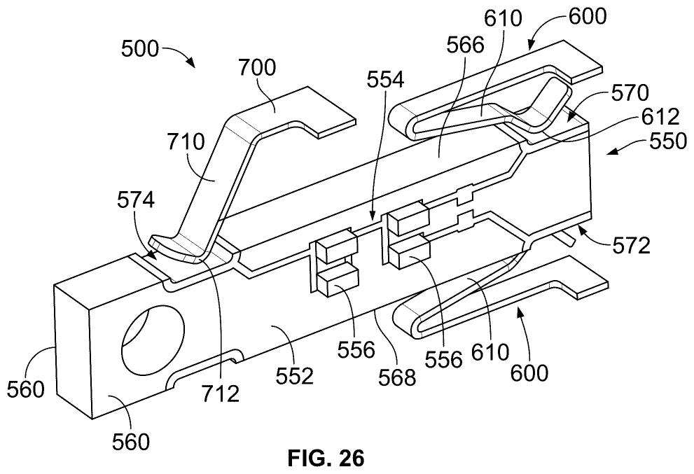

FIG. 26 is a perspective view of the signal processing assembly 550 in accordance with an exemplary embodiment showing the jumper contacts 600 and the ground jumper contact 700 coupled to the signal processing assembly 550. The signal processing assembly 550 includes the end node PCB 552, the end node control circuit 554, and the signal processing components 556 mounted to the end node PCB 552. While the signal processing components 556 are shown mounted to one of the surfaces 560, the signal processing components 556 may be mounted to both of the surfaces 560 at opposite sides of the end node PCB 552 in alternative embodiments. The signal edge pads 570, 572 and the ground edge pad 574 are shown at the first and second edges 566, 568 (for example, between the opposite surfaces 560 of the end node PCB 552).

The jumper contacts 600 include end node spring beams 610 having end node mating interfaces 612 electrically connected to the corresponding signal edge pads 570, 572. The end node spring beams 610 are deflectable and have separable mating interfaces. The end node spring beams 610 are configured to be mated to the signal edge pads 570, 572 when the end node termination module 500 is plugged into the plug housing 210 of the plug connector 200.

The ground jumper contact 700 includes an end node spring beam 710 having an end node mating interface 712 electrically connected to the corresponding ground edge pad 574. The end node spring beam 610 is deflectable and has a separable mating interface. The end node spring beam 710 is configured to be mated to the ground edge pad 574 when the end node termination module 500 is plugged into the plug housing 210 of the plug connector 200.

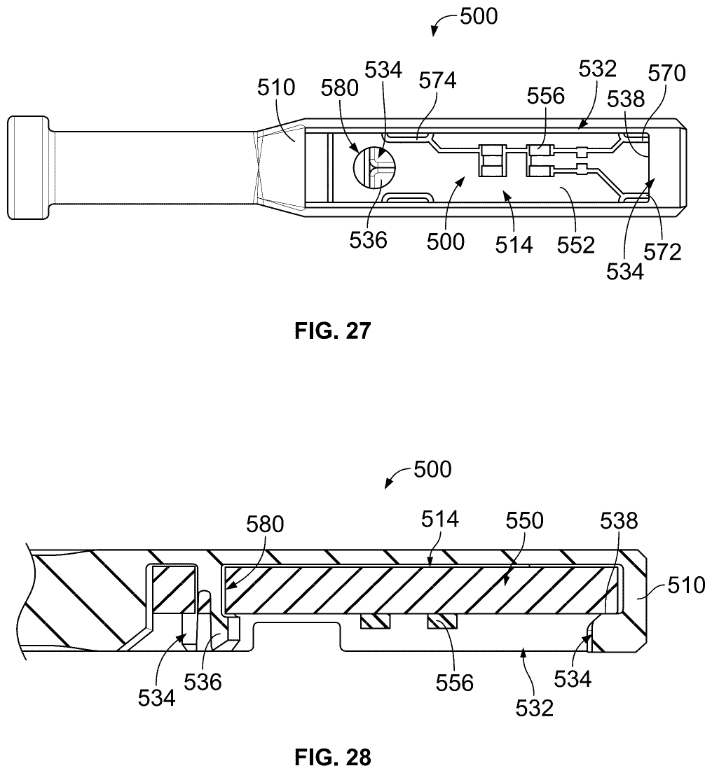

FIG. 27 is a side view of the end node termination module 500 in accordance with an exemplary embodiment. FIG. 28 is a cross-sectional view of the end node termination module 500 in accordance with an exemplary embodiment. FIGS. 27 and 28 illustrates the signal processing assembly 550 in the pocket 514 of the termination module housing 510.

When assembled, the end node PCB 552 is coupled to the fixation features 534 of the termination module housing 510. For example, the post 536 is received in the opening 580. The post 536 aligns the end node PCB 552 in the pocket 514. In an exemplary embodiment, a distal end of the post 536 includes capture features that capture and retain the end node PCB 552 in the pocket 514. The capture wall 538 captures the front end of the end node PCB 552 in the pocket 514. For example, the end node PCB 552 is unable to be removed through the loading opening 532 when the front end of the end node PCB 552 is located behind the capture wall 538. In an exemplary embodiment, the end node PCB 552 and the signal processing components 556 are completely contained within the footprint of the termination module housing 510. When assembled, the end node PCB 552 is positioned within the pocket 514 such that the signal edge pads 570, 572 are aligned with the corresponding access windows 540 and the ground edge pad 574 is aligned with the corresponding ground access opening 542. The access windows 540, 542 provide access to the edge pads 570, 572, 574.

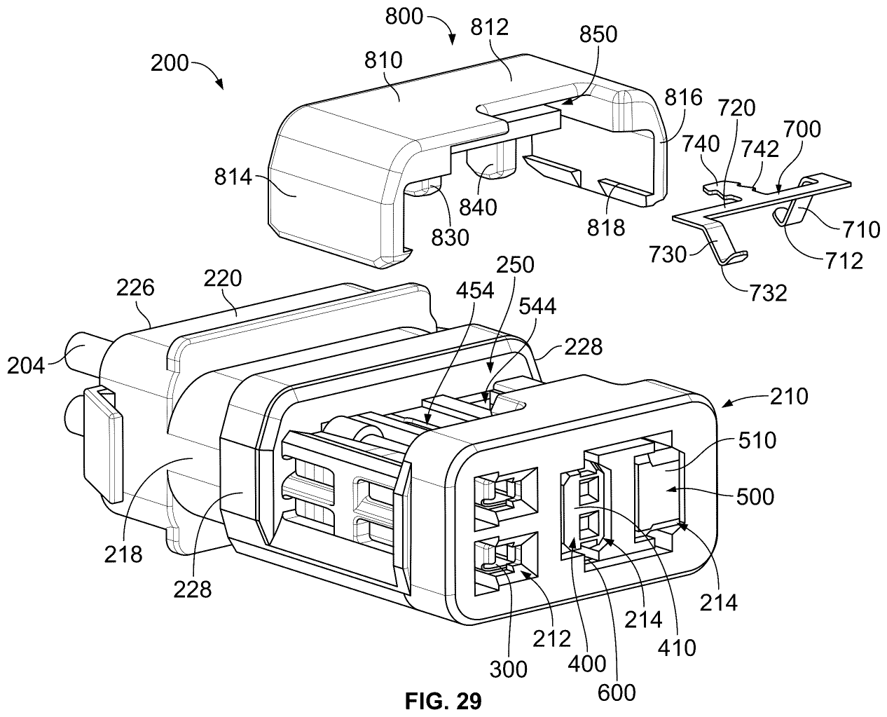

FIG. 29 is an exploded view of a portion of the plug connector 200 in accordance with an exemplary embodiment. FIG. 29 shows the inner housing 218 holding the power contacts 300, the data module 400, and the end node termination module 500. It is noted that the outer housing 216 (FIG. 8) is removed for clarity to illustrate portions of the inner housing 218. FIG. 29 additionally illustrates a position assurance device 800 used to assure positioning of the power contacts 300, the data module 400, and the end node termination module 500 within the plug housing 210. In an exemplary embodiment, the position assurance device 800 is configured to hold the ground jumper contact 700. The position assurance device 800 may additionally or alternatively hold the jumper contacts 600.

In an exemplary embodiment, the plug housing 210 includes a position assurance device pocket 250 that receives the position assurance device 800. The position assurance device pocket 250 may be open at the top 220 to receive the position assurance device 800, such as in a downward mating direction. The position assurance device pocket 250 may additionally or alternatively be open at one or both of the sides 228 to receive the position assurance device 800. In an exemplary embodiment, the power contact channels 212 and the module channels 214 are accessible to the position assurance device pocket 250. As such, the position assurance device 800 is configured to interface with the power contacts 300 and the power contact channels 212 and interface with the data module 400 and end node termination module 500 in the corresponding module channels 214.

During assembly, the power contacts 300 are loaded into the power contact channels 212 through the rear 226 of the plug housing 210. The plug housing 210 may include latches or other securing features to retain the power contacts 300 in the plug housing 210. The plug housing 210 may include positioning features, such as stop walls to position the power contacts 300 in the power contact channels 212, such as to limit forward loading of the power contacts 300 into the power contact channels 212. The position assurance device 800 is configured to be coupled to the plug housing 210 to assure that the power contacts 300 are correctly loaded into the plug housing 210. For example, the position assurance device 800 may be unable to mate to the plug housing 210 if the power contacts 300 are not fully loaded into the power contact channels 212. In various embodiments, the position assurance device 800 is configured to interface with the latches that hold the power contacts 300 in the power contact channels 212 to prevent unlatching of latches and/or to prevent buckling or breaking of the latches when the power cables 204 are pulled rearwardly.

During assembly, the data module 400 is loaded into the module channel 214 through the rear 226 of the plug housing 210. The plug housing 210 may include a latch or other securing feature to retain the data module 400 in the plug housing 210. The plug housing 210 may include positioning features, such as stop walls, to position the data module 400 and the module channel 214, such as to limit forward loading of the data module 400 into the module channel 214. The position assurance device 800 is configured to be coupled to the plug housing 210 to assure that the data module 400 is correctly loaded into the plug housing 210. For example, the position assurance device 800 may be unable to mate to the plug housing 210 if the data module 400 is not fully loaded into the module channel 214. In various embodiments, the position assurance device 800 is configured to interface directly with the data module 400 to retain the data module 400 in the module channel 214.

During assembly, the end node termination module 500 is loaded into the module channel 214 through the rear 226 of the plug housing 210. The plug housing 210 may include a latch or other securing feature to retain the end node termination module 500 in the plug housing 210. The plug housing 210 may include positioning features, such as stop walls, to position the end node termination module 500 and the module channel 214, such as to limit forward loading of the end node termination module 500 into the module channel 214. The position assurance device 800 is configured to be coupled to the plug housing 210 to assure that the end node termination module 500 is correctly loaded into the plug housing 210. For example, the position assurance device 800 may be unable to mate to the plug housing 210 if the end node termination module 500 is not fully loaded into the module channel 214. In various embodiments, the position assurance device 800 is configured to interface directly with the end node termination module 500 to retain the end node termination module 500 in the module channel 214.

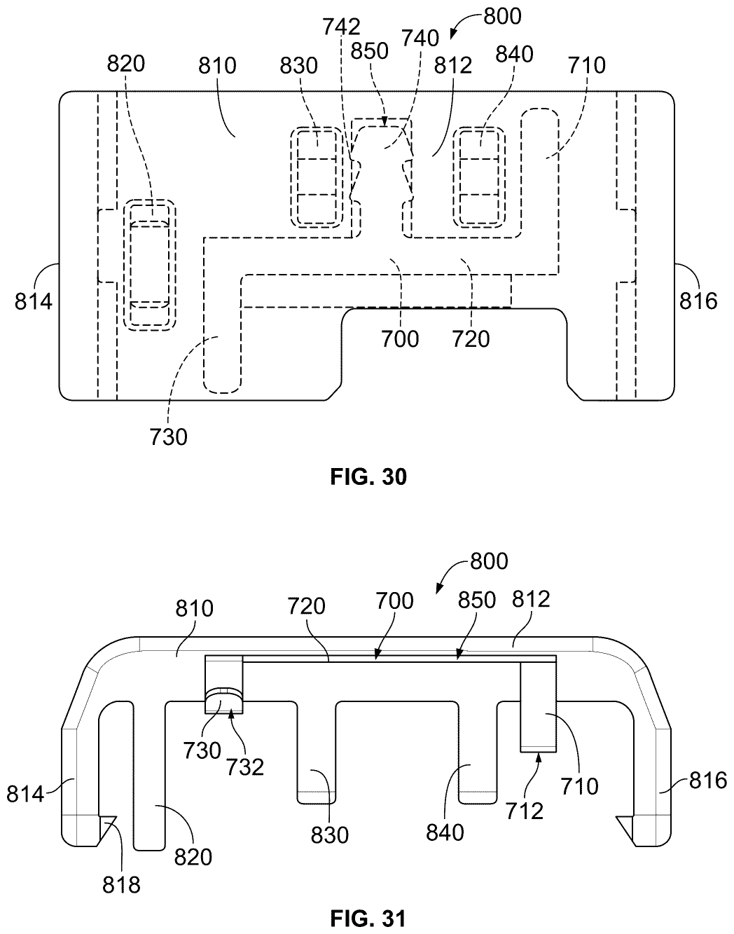

With additional reference to FIG. 30, which is a top view of the position assurance device 800, and FIG. 31, which is an end view of the position assurance device 800, the position assurance device 800 holds the ground jumper contact 700. In an exemplary embodiment, the position assurance device 800 includes a body 810 having an end wall 812, a first side wall 814 extending from a first side of the end wall 812, and a second side wall 816 extending from a second side of the end wall 812. The end wall 812 is configured to be coupled to the top 220 of the plug housing 210. The side walls 814, 816 are configured to be coupled to the sides 228 of the plug housing 210. In an exemplary embodiment, the side walls 814, 816 include latching elements 818 configured be latchably coupled to the sides 228 of the plug housing 210 to secure the position assurance device 800 to the plug housing 210. Other types of securing features may be used in alternative embodiments.

In an exemplary embodiment, the position assurance device 800 includes a primary latch lock 820 extending from the end wall 812. The primary latch lock 820 is configured to interface with the latches of the plug housing 210 that secure the power contacts 300 in the power contact channels 212. Optionally, multiple primary latch locks 820 may be provided, such as for interfacing with different latches used to secure the different power contacts 300. In the illustrated embodiment, the primary latch lock 820 is a beam or post extending downward from the inner surface of the end wall 812. The primary latch lock 820 may be rectangular in shape. The distal end of the primary latch lock 820 may be chamfered to guide assembly. However, the primary latch lock 820 may have other shapes in alternative embodiments.

In an exemplary embodiment, the position assurance device 800 includes a data module lock 830 extending from the end wall 812. The data module lock 830 is configured to interface with the data module 400 to secure the data module 400 in the module channel 214. For example, the data module lock 830 may be sized and shaped to fit in the locking slot 454 of the data module housing 410 to secure the data module 400 in the module channel 214. In the illustrated embodiment, the data module lock 830 is a beam or post extending downward from the inner surface of the end wall 812. The data module lock 830 may be rectangular in shape. The distal end of the data module lock 830 may be chamfered to guide assembly. However, the data module lock 830 may have other shapes in alternative embodiments.

In an exemplary embodiment, the position assurance device 800 includes a end node termination module lock 840 extending from the end wall 812. The end node termination module lock 840 is configured to interface with the end node termination module 500 to secure the end node termination module 500 in the module channel 214. For example, the end node termination module lock 840 may be sized and shaped to fit in the locking slot 544 of the termination module housing 510 to secure the end node termination module 500 in the module channel 214. In the illustrated embodiment, the end node termination module lock 840 is a beam or post extending downward from the inner surface of the end wall 812. The end node termination module lock 840 may be rectangular in shape. The distal end of the end node termination module lock 840 may be chamfered to guide assembly. However, the end node termination module lock 840 may have other shapes in alternative embodiments. The end node termination module lock 840 may lock other components in the housing, such as a data module when set up as a two-position data module arrangement.

In an exemplary embodiment, the position assurance device 800 includes a ground jumper contact channel 850 that receives the ground jumper contact 700. The ground jumper contact channel 850 may be open at the front of the position assurance device 800 to receive the ground jumper contact 700. The position assurance device 800 holds the ground jumper contact 700 and positions the ground jumper contact 700 to mate with the end node termination module 500 and an electrically grounded component of the plug connector 200. In an exemplary embodiment, the negative power contact 300 is connected to a reference ground and defines a grounded component of the plug connector 200. The ground jumper contact 700 is configured to mate with the negative power contact 300.

In an exemplary embodiment, the ground jumper contact 700 is a stamped and formed contact. The ground jumper contact 700 includes a connecting beam 720 extending between the end node spring beam 710 and a ground connection spring beam 730. The end node spring beam 710 includes the end node mating interface 712. The ground connection spring beam 730 includes a ground connection mating interface 732. The spring beams 710, 730 are deflectable spring beams. The spring beams 710, 730 may extend downward from the connecting beam 720 to interface with the end node termination module 500 and the power contact 300. The spring beams 710, 730 may be deflected upward when mated to the end node termination module 500 and the power contact 300. In the illustrated embodiment, the spring beams 710, 730 extend in different directions. For example, the end node spring beam 710 extends rearwardly from the connecting beam 720 whereas the ground connection spring beam 730 extends forwardly from the connecting beam 720. However, in alternative embodiments, the spring beams 710, 730 may be oriented differently, such as extending in the same directions. The spring beams 710, 730 may have different lengths such that the mating interfaces 712, 732 are at different vertical heights for mating with the end node termination module 500 and the power contact 300.

In an exemplary embodiment, the ground jumper contact 700 includes a mating tab 740 used for mating the ground jumper contact 700 to the position assurance device 800. In the illustrated embodiment, the mating tab 740 extends from the connecting beam 720, such as rearwardly from the connecting beam 720. The mating tab 740 includes barbs 742 along side edges of the mating tab 740. The barbs 742 are configured to dig into the plastic material of the position assurance device 800 to secure the ground jumper contact 700 in the ground jumper contact channel 850. Other types of mating features may be used in alternative embodiments to secure the ground jumper contact 700 to the position assurance device 800.

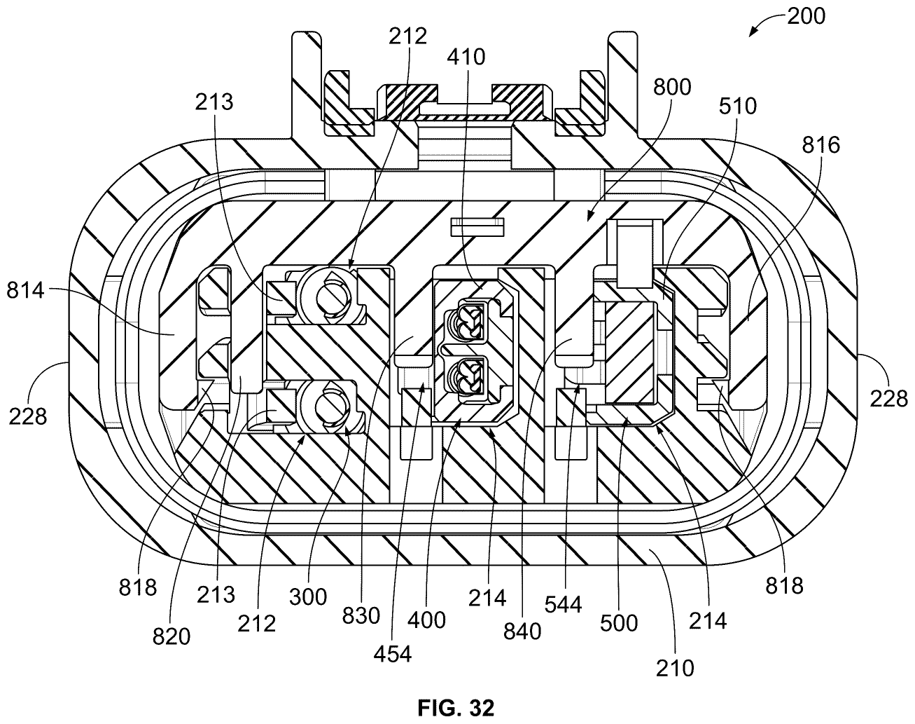

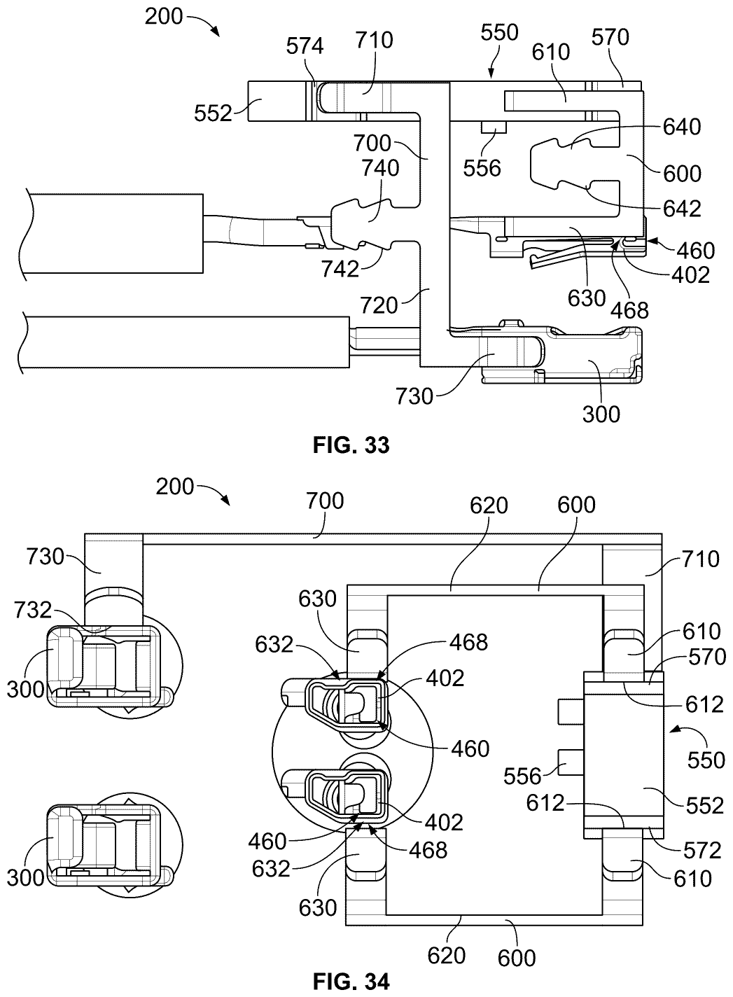

FIG. 32 is a cross-sectional view of the plug connector 200 in accordance with an exemplary embodiment. FIG. 32 shows the position assurance device 800 coupled to the plug housing 210. FIG. 32 shows the position assurance device 800 interfacing with the power contacts 300, the data module 400, and the end node termination module 500. When assembled, the position assurance device 800 is coupled to the plug housing 210. For example, the latching elements 818 at the side walls 814, 816 are configured to be coupled to the latching features along the sides 228 of the plug housing 210. Optionally, the latching features along the sides 228 may have staged latching positions to allow positioning of the position assurance device 800 at different stage positions, such as an initial coupled position and a final coupled position.

When assembled, the primary latch lock 820 is configured to interface with the primary latches 213 of the plug housing 210 that secure the power contacts 300 in the power contact channels 212. The primary latch lock 820 supports or holds the primary latches 213 in the latched positions to prevent unlatching and prevent damage to the primary latches 213. When assembled, the data module lock 830 is configured to interface with the data module 400 to secure the data module 400 in the module channel 214. For example, the data module lock 830 fits in the locking slot 454 of the data module housing 410 to secure the data module 400 in the module channel 214. When assembled, the end node termination module lock 840 is configured to interface with the end node termination module 500 to secure the end node termination module 500 in the module channel 214. For example, the end node termination module lock 840 fits in the locking slot 544 of the termination module housing 510 to secure the end node termination module 500 in the module channel 214.

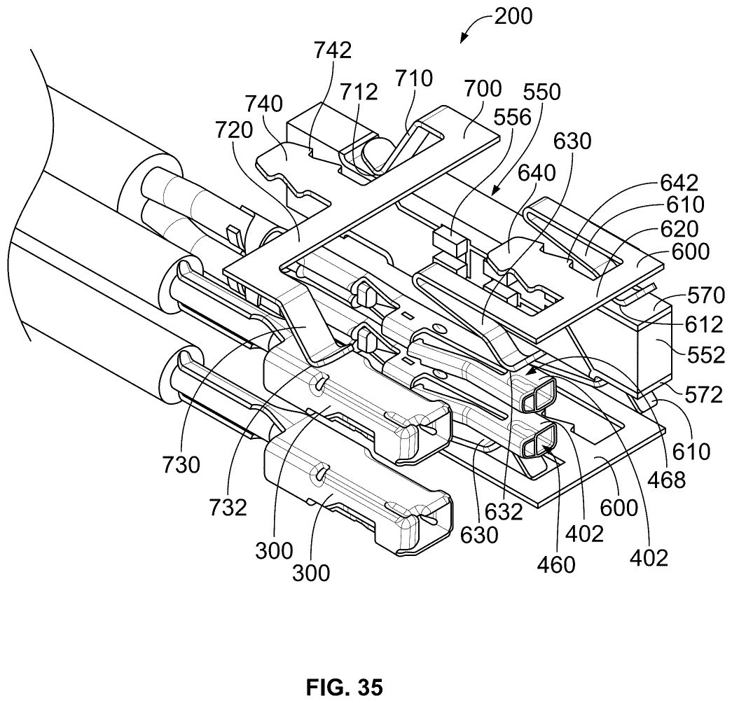

FIG. 33 is a perspective view of a portion of the plug connector 200 in accordance with an exemplary embodiment showing the internal components of the plug connector 200. FIG. 34 is a top view of a portion of the plug connector 200 in accordance with an exemplary embodiment showing the internal components of the plug connector 200. FIG. 35 is a front view of a portion of the plug connector 200 in accordance with an exemplary embodiment showing the internal components of the plug connector 200. FIGS. 33-35 illustrate an embodiment of the plug connector 200 operating in a common mode end node configuration. The plug housing 210, data module housing 410, and termination module housing 510 are removed in FIGS. 33-35 to illustrate the power contacts 300, the signal contacts 402, the signal processing assembly 550, the jumper contacts 600, and the ground jumper contact 700.

In the common mode end node configuration, the jumper contacts 600 are connected between the signal contacts 402 and the signal processing assembly 550 and the ground jumper contact 700 is connected between the ground referenced power contact 300 and the signal processing assembly 550. The signal processing components 556 perform signal processing onboard of the signal processing assembly 550 within the plug connector 200 without the need for separate signal processing at the header connector 100 or the circuit board 102 associated with the header connector 100.

The ground jumper contact 700 is a stamped and formed contact. The jumper contact 700 includes the connecting beam 720 extending between the end node spring beam 710 and the ground connection spring beam 730. The end node spring beam 710 includes the end node mating interface 712. The ground connection spring beam 730 includes the ground connection mating interface 732. The spring beams 710, 730 are deflectable spring beams. The spring beams 710, 730 extend from the connecting beam 720 to interface with the corresponding ground edge pad 574 of the end node PCB 552 and the power contact 300, respectively. In an exemplary embodiment, the ground connection spring beam 730 is configured to interface directly with the interface surface 478 of the power contact 300. The spring beams 710, 730 may be deflected when mated to the signal processing assembly 550 and the power contact 300. The ground jumper contact 700 includes the mating tab 740 with the barbs 742 along side edges of the mating tab 740.

In an exemplary embodiment, each jumper contact 600 is a stamped and formed contact. The jumper contact 600 includes a connecting beam 620 extending between the end node spring beam 610 and a signal contact spring beam 630. The end node spring beam 610 includes the end node mating interface 612. The signal contact spring beam 630 includes a signal contact mating interface 632. The spring beams 610, 630 are deflectable spring beams. The spring beams 610, 630 extend from the connecting beam 620 to interface with the corresponding signal edge pads 570, 572 of the end node PCB 552 and the signal contact 402, respectively. In an exemplary embodiment, the signal contact spring beam 630 is configured to interface directly with the interface surface 468 at the mating end 470 of the socket contact 402. The spring beams 610, 630 may be deflected when mated to the signal processing assembly 550 and the signal contact 402.

In an exemplary embodiment, the jumper contact 600 includes a mating tab 640 used for mating the jumper contact 600 to the plug housing 210. In the illustrated embodiment, the mating tab 640 extends from the connecting beam 620, such as rearwardly from the connecting beam 620. The mating tab 640 includes barbs 642 along side edges of the mating tab 640. The barbs 642 are configured to dig into the plastic material of the plug housing 210 to secure the jumper contact 600 in a jumper contact channel of the plug housing 210. Other types of mating features may be used in alternative embodiments to secure the jumper contact 600 to the plug housing 210 or other component, such as the position assurance device 800.

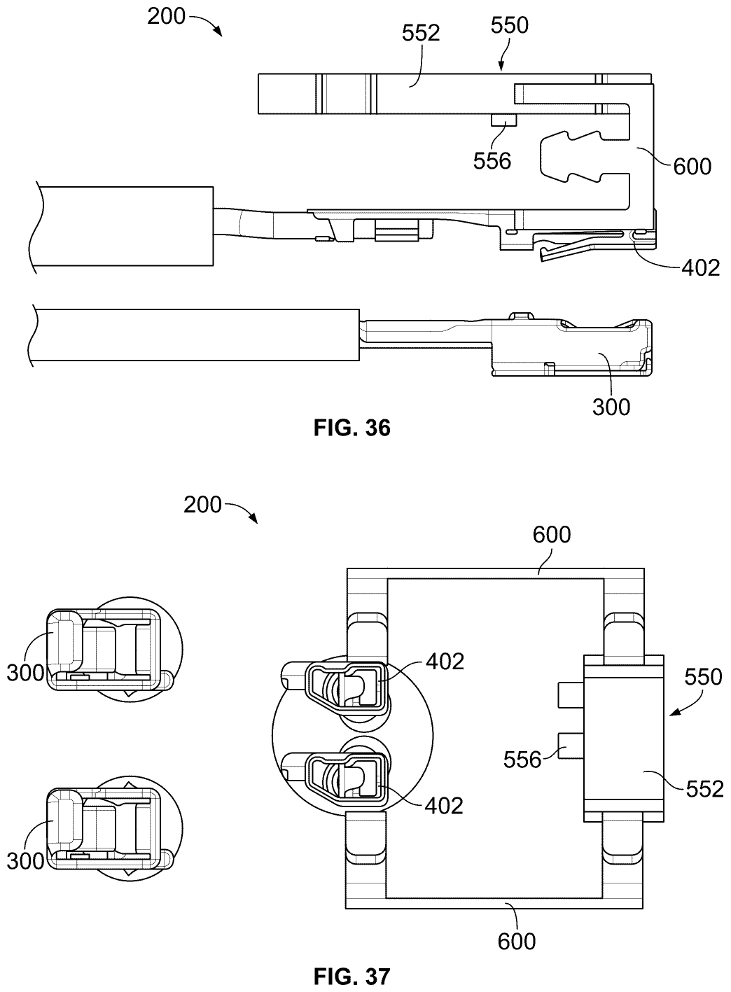

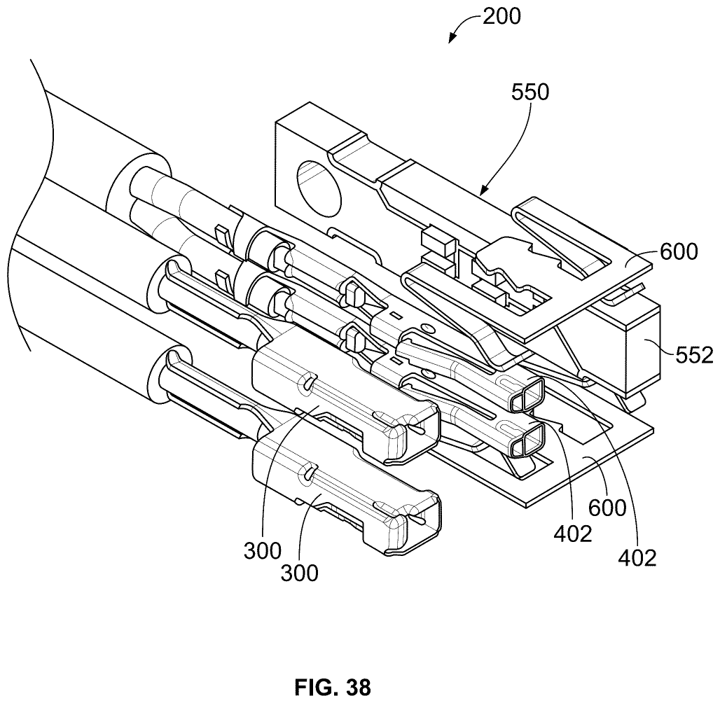

FIG. 36 is a perspective view of a portion of the plug connector 200 in accordance with an exemplary embodiment showing the internal components of the plug connector 200. FIG. 37 is a top view of a portion of the plug connector 200 in accordance with an exemplary embodiment showing the internal components of the plug connector 200. FIG. 38 is a front view of a portion of the plug connector 200 in accordance with an exemplary embodiment showing the internal components of the plug connector 200. FIGS. 36-38 illustrate an embodiment of the plug connector 200 operating in a differential mode end node configuration. The plug housing 210, data module housing 410, and termination module housing 510 are removed in FIGS. 36-38 to illustrate the power contacts 300, the signal contacts 402, the signal processing assembly 550, and the jumper contacts 600. The ground jumper contact 700 is not necessary for the differential mode end node configuration. For example, the end node PCB 552 does not need to be connected to ground in the differential mode end node configuration.

In the differential mode end node configuration, the jumper contacts 600 are connected between the signal contacts 402 and the signal processing assembly 550. The signal processing components 556 perform signal processing onboard of the signal processing assembly 550 within the plug connector 200 without the need for separate signal processing at the header connector 100 or the circuit board 102 associated with the header connector 100.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A plug connector comprising:
a plug housing having a mating end and a cable end, the mating end configured to be mated with a header connector, the plug housing including a power contact channel between the mating end and the cable end, the plug housing including a first module channel between the mating end and the cable end, the plug housing including a second module channel between the mating end and the cable end;
a power contact received in the power contact channel, the power contact being terminated to a power cable, the power contact including a mating end configured to be mated to the header connector;
a data module received in the first module channel, the data module including a data module housing holding signal contacts terminated to ends of signal wires of a data cable, each signal contact including a mating end configured to be mated to the header connector;
an end node termination module received in the second module channel, the end node termination module including a termination module housing with a pocket, the end node termination module including an end node printed circuit board (PCB) received in the pocket, the end node PCB including an end node control circuit having an end node control component mounted to the end node PCB to control the end node control circuit;
jumper contacts held by the plug housing, each jumper contact including a signal contact mating interface electrically connected to the corresponding signal contact and an end node mating interface electrically connected to the end node termination module to electrically connect the signal contacts to the end node control circuit within the plug connector.

2. The plug connector of claim 1, wherein the first module channel and the second module channel are identical such that the data module and the end node termination module are interchangeably receivable in the first and second module channels.

3. The plug connector of claim 1, wherein the data module is a first data module, the plug connector further comprising a second data module received in a third module channel of the plug housing.

4. The plug connector of claim 1, wherein the end node control component is one of a common mode end node control component or a differential mode end node control component.

5. The plug connector of claim 1, wherein the plug housing includes jumper contact channels extending between the first module channel and the second module channel, the jumper contact channels receiving the jumper contacts.

6. The plug connector of claim 1, wherein the end node PCB includes a first surface and a second surface, the end node PCB including a first edge and a second edge between the first and second surfaces, the end node control component mounted to the first surface, the end node PCB including a first signal edge pad along the first edge and a second signal edge pad along the second edge, the first and second signal edge pads coupled to the end node control circuit, the jumper contacts coupled to the first and second signal edge pads.

7. The plug connector of claim 6, wherein the end node control component is coupled to the end node control circuit between the first and second signal edge pads.

8. The plug connector of claim 6, wherein the end node PCB includes a ground edge pad along the first edge, the plug connector further comprising a ground jumper contact configured to be coupled to an electrically grounded component of the plug connector, the ground jumper contact being coupled to the ground edge pad.

9. The plug connector of claim 8, wherein the ground jumper contact is coupled to the power contact, the power contact being connected to a grounded return path and defining the electrically grounded component of the plug connector.

10. The plug connector of claim 1, wherein the end node PCB and the end node control component are contained within the pocket of the termination module housing.

11. The plug connector of claim 1, wherein the termination module housing includes access windows, the jumper contacts passing through the access windows to electrically connect with the end node PCB.

12. The plug connector of claim 1, wherein the termination module housing includes a loading opening at a side of the termination module housing, the end node PCB being loaded into the pocket through the loading opening.

13. The plug connector of claim 12, wherein the termination module housing includes a fixation mechanism to hold the end node PCB in the pocket.

14. The plug connector of claim 1, further comprising a ground jumper contact coupled to an electrically grounded component of the plug connector, the ground jumper contact including a ground contact mating interface electrically connected to the end node termination module to electrically ground the end node termination module.

15. The plug connector of claim 1, further comprising a position assurance device coupled to the plug housing, the position assurance device interfacing with the data module to assure positioning of the data module in the first module channel and retain the data module in the plug housing, the position assurance device interfacing with the end node termination module to assure positioning of the end node termination module in the second module channel and retain the end node termination module in the plug housing.

16. The plug connector of claim 15, wherein the data module housing includes a notch, the position assurance device including a first positioning tab configured to be received in the notch of the data module housing, the termination module housing including a notch, the position assurance device including a second positioning tab configured to be received in the notch of the termination module housing.

17. The plug connector of claim 1, wherein the jumper contact includes a signal contact mating beam including the signal contact mating interface and an end node mating beam including the end node mating interface, the jumper contact including a connecting beam between the signal contact mating beam and the end node mating beam, the signal contact mating beam and the end node mating beam being deflectable relative to the connecting beam.

18. An end node termination module for a plug connector comprising:
a termination module housing including a main body having a pocket, the main body including an access window open to the pocket; and
an end node printed circuit board (PCB) received in the pocket, the end node PCB including an end node control circuit having an end node control component mounted to the end node PCB to control the end node control circuit;
wherein the end node PCB is configured to be electrically connected to at least one of a power contact of the plug connector and a signal contact of the plug connector by at least one jumper contact of the plug connector through the access window.

19. The end node termination module of claim 18, wherein the end node PCB includes a first surface and a second surface, the end node PCB including a first edge and a second edge between the first and second surfaces, the end node PCB including an end node control circuit having an end node control component mounted to the first surface, the end node PCB including a first signal edge pad along the first edge and a second signal edge pad along the second edge, the first and second signal edge pads coupled to the end node control circuit, the at least one jumper contact includes a first signal jumper contact coupled to the first signal edge pad and a second signal jumper contact coupled to the second signal edge pad.

20. The end node termination module of claim 19, wherein the end node PCB includes a ground edge pad along the first edge configured to be coupled to a ground jumper contact of the at least one jumper contacts that is coupled to an electrically grounded component of the plug connector.

21. An electrical connector system comprising:
a header connector including a header housing holding header contacts, the header housing including a receptacle, the header contacts including mating ends in the receptacle; and
a plug connector received in the receptacle and mated to the header contacts, the plug connector comprising:
a plug housing having a mating end and a cable end, the mating end configured to be mated with the header connector, the plug housing including a power contact channel between the mating end and the cable end, the plug housing including a first module channel between the mating end and the cable end, the plug housing including a second module channel between the mating end and the cable end;
a power contact received in the power contact channel, the power contact being terminated to a power cable, the power contact including a mating end configured to be mated to the corresponding header contact of the header connector;
a data module received in the first module channel, the data module including a data module housing holding signal contacts terminated to ends of signal wires of a data cable, each signal contact including a mating end configured to be mated to the corresponding header contact of the header connector;
an end node termination module received in the second module channel, the end node termination module including a termination module housing with a pocket, the end node termination module including an end node printed circuit board (PCB) received in the pocket, the end node PCB including an end node control circuit having an end node control component mounted to the end node PCB to control the end node control circuit;
jumper contacts held by the plug housing, each jumper contact including a signal contact mating interface electrically connected to the corresponding signal contact and an end node mating interface electrically connected to the end node termination module to electrically connect the signal contacts to the end node control circuit within the plug connector.
